(19) United States
(12) Patent Application Publication
(10) Pub. No.: US 2008/0015832 A1
(43) Pub. Date: Jan. 17, 2008

(54) Method for Predicting Acid Placement in Carbonate Reservoirs

(76) Inventor: Philippe Tardy, Stafford, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/564,584

(22) Filed: Nov. 29, 2006

Related U.S. Application Data
(63) Continuation-in-part of application No. 11/456,778, filed on Jul. 11, 2006.

(51) Int. Cl. G06G 7/48

(52) U.S. Cl. 703/10

(57) ABSTRACT

A computationally efficient general method of modeling or simulating matrix acidizing treatment when flow is not axisymmetric involves determining streamlines in the general flow field using complex potential theory to solve for the flow along the streamlines. The flow over a time step is used to model the propagation of the acid front and the creation and extension of wormholes.

### CROSS-REFERENCE TO RELATED APPLICATIONS

This application is a continuation-in-part of U.S. patent application Ser. No. 11/456,778, “Flow of Self-Diverting Acids in Carbonate Reservoirs”, filed on Jul. 11, 2006. The disclosure of the above application is incorporated herein by reference.

### FIELD OF THE INVENTION

The invention relates to acid stimulation of hydrocarbon bearing subsurface formations and reservoirs. In particular, the invention relates to methods of optimizing field treatment of the formations.

### BACKGROUND

Matrix acidizing is a process used to increase the production rate of wells in hydrocarbon reservoirs. It includes the step of pumping an acid into an oil- or gas-producing well to increase the permeability of the formation through which hydrocarbon is produced and to remove some of the formation damage caused by the drilling and completion fluids and drill bits during the drilling and completion process.

The procedural techniques for pumping stimulation fluids down a wellbore to acidize a subterranean formation are well known. The person who designs such matrix acidizing treatments has available many useful tools to help design and implement the treatments, one of which is a computer program commonly referred to as an acid placement simulation model (a.k.a., matrix acidizing simulator, wormhole model). Most if not all commercial service companies that provide matrix acidizing services to the oilfield have one or more simulation models that their treatment designers use. One commercial matrix acidizing simulation model that is widely used by several service companies is known as StimCADE™. This commercial computer program is a matrix acidizing design, prediction, and treatment-monitoring program that was designed by Schlumberger Technology Corporation. All of the various simulation models use information available to the treatment designer concerning the formation to be treated and the various treatment fluids (and additives) in the calculations, and the program output is a pumping schedule that is used to pump the stimulation fluids into the wellbore. The text “Reservoir Stimulation,” Third Edition, Edited by Michael J. Economides and Kenneth G. Nolte, Published by John Wiley & Sons, (2000), is an excellent reference book for matrix acidizing and other well treatments.

Various mathematical models have been proposed in order to represent the flow of acid within the carbonate formations around the wellbore and the subsequent dissolution of the rock matrix where acid has invaded. Then, according to the prediction of these models, engineers can estimate how much the well will produce after treatment and, therefore, estimate whether a given treatment design will lead to the targeted production increase and optimize the design accordingly. The models proposed in the literature are developed to represent acid flow in radial flow, i.e. axisymmetric, conditions as could be observed in some particular conditions. But axisymmetric flow conditions are not always present. It would be a major advance to provide
a criterion to determine under which radial flow, i.e. axisymmetric flow, is relevant,
a method to solve acid flow when acid flow around the wellbore is not axisymmetric.

### SUMMARY

A computationally efficient general method of modeling or simulating matrix acidizing treatment when flow is not axisymmetric involves determining streamlines in the general flow field using complex potential theory to solve for the flow along the streamlines. The flow over a time step is used to model the propagation of the acid front and the creation and extension of wormholes.

For self diverting acids, the flow along the streamlines is solved with the use of flow parameters Θᵣ and Δpᵣ derived from core flood experiments.

Methods of optimizing matrix acidizing treatment involve doing the calculations in an optimization loop based on user input of operational parameters and parameters associated with the geological formation and acidizing fluid.

### BRIEF DESCRIPTION OF THE DRAWINGS

FIG. 1 shows a typical experimental apparatus for acid injection into a rock core;

FIG. 2 illustrates the pressure-drop evolution for non-diverting acid systems such as HCl. 2A: schematic, 2B: actual data;

FIG. 3 illustrates the pressure drop evolution for self-diverting acid systems such as VDA™. 3A: schematic, 3B: example of actual data;

FIG. 4 shows a multi pressure tap/transducer core-flooding apparatus;

FIG. 5 shows the evolution of the effective viscosity μₑ with the number of pore volumes injected for a self-diverting acid;

FIG. 6 illustrates a flow pattern in the core when a self diverting acid is pumped;

FIGS. 7a and 7b illustrate axisymmetric flow around a wellbore;

FIG. 8 shows a wellbore trajectory in a bedding plane;

FIG. 9 is an example of a well segmentation and reservoir layering according to criterion (24). Horizontal flow in the upper part of the reservoir and vertical confined flow in the lower part of the reservoir;

FIG. 10 is an example of workflow for solving flow around a wellbore segment in the corresponding reservoir layer;

FIG. 11 is a flow domain in a layer perpendicular to the bedding plane;

FIG. 12 is a flow domain after resealing;

FIG. 13 shows a set of source points along the wellbore contour of the invention of disclosure;

FIG. 14a shows a set of streamlines [140] computed with a permeability ratio kₕ/kᵥ=5. The wellbore is located at 1.4 m from the top (y=0) impermeable barrier [142]. Another impermeable barrier [143] is located at the bottom y=h=31.8 m. FIG. 14b is a zoom of FIG. 14a around the wellbore;

FIG. 15a shows a set of streamlines [150] computed with a permeability ratio kₕ/kᵥ=5. The wellbore [151] is located at 15.75 m from the top (y=0) impermeable barrier [152]. Another impermeable barrier [153] is located at the bottom y=h=31.8 m. FIG. 15b is a zoom of FIG. 15a around the wellbore;

FIG. 16 shows a streamline with velocity and pressure gradient at a point (x,y);

FIGS. 17a and 17b are graphs showing a control volume [170] around a point s̅_{k,i} on the streamline Stₖ for finite volume calculations;

FIG. 18 illustrates updating of the streamlines after each time step. [181]: extent of the wormholed zone after first time step. [182]: extent of the wormholed zone after second time step;

FIG. 19 shows a treatment design methodology in the field;

FIG. 20 shows a wellbore penetrating two (bottom and top) reservoir zones; and

FIG. 21 shows a depth of invasion of the wormhole for 4 different injected volumes: 21a: 25 gal/ft; 21b: 50 gal/ft; 21c: 75 gal/ft; 21d: 100 gal/ft.

FIGS. 22 and 23 show streamlines calculated for flow around a wellbore.

### DESCRIPTION

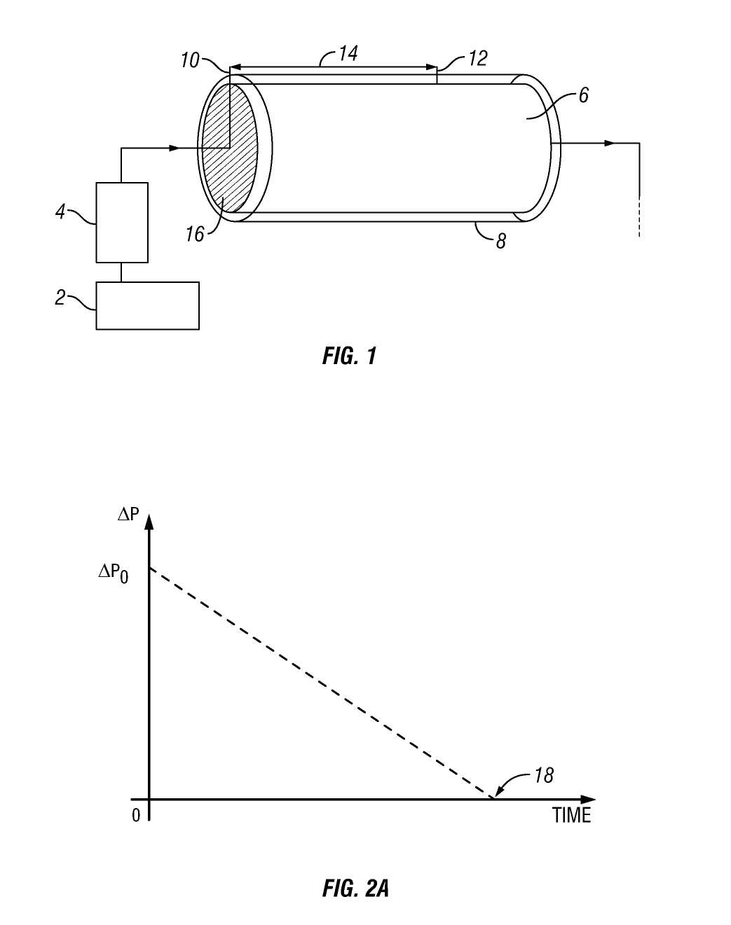

In order to predict the outcome of the pumping of an acid, or of acid stages, into a reservoir, engineers go through a design process, which can be divided into several steps. In the first step, different acids are injected, for testing, into cylindrical rock cores, under various conditions. FIG. 1 is an illustration of a typical experimental setup used for injecting acid into a core. A pump [2] pumps a fluid, for example an acid, through an accumulator [4] into a core [6] held in a core holder [8]. During such tests, the following parameters will normally be varied:
Injection rate: Q
Temperature: T
Acid formulation: Ac
Rock type: Ro

As acid flows into the rock, it dissolves part of the rock matrix and increases the overall permeability of the core with time. Depending on the combination of the above parameters, the dissolution pattern inside the rock can vary between face dissolution (also known as compact dissolution), wormholing dissolution, and uniform dissolution. These three dissolution regimes give rise to different acid efficiencies. Acid efficiency is measured as the amount of acid that is required by the rock core to increase its permeability to a pre-set value k_{w}, for instance 100 times larger than the initial permeability k₀ of the sample. The smaller this volume of acid is, the higher the efficiency is. The moment at which this target value of permeability increase is reached is called the breakthrough time, t₀. The corresponding volume of acid is called the breakthrough volume, Vol₀.

The measure of pore volumes to breakthrough, denoted Θ₀, (i.e. the breakthrough volume divided by the pore volumes of the core PV (the volume of fluid that can be contained in the core), and its use to predict acid performance during a treatment job has been known to the industry for a long time. If we define Vol as being the geometrical volume of the core and φ₀ the initial porosity of the core (i.e. the fraction of the core volume that can be occupied by a fluid through the pore space network), these parameters are linked to each other as follows:

$${Θ}_{0} = \frac{{Vol}_{0}}{PV} = \frac{{Qt}_{0}}{PV} where PV = {φ}_{0} \times Vol \qquad ( 1 )$$

Pore volume to breakthrough has widely been used as a measure of the velocity at which wormholes propagate into the formation, under various conditions such as mean flow-rate Q, temperature T, rock-type Ro, and acid formulation Ac.

In one embodiment, a method for solving the flow of acid from a wellbore segment to a corresponding reservoir layer during a matrix acidizing simulation, comprising:
(a) Defining the initial geometry of the domain in which the flow problem is to be solved;
(b) Determining the complex potential associated with the flow problem in the domain under consideration;
(c) Determining streamlines from the complex potential in the domain under consideration;
(d) Using the streamlines to solve flow over a time step δt to propagate acid within the domain and update wormhole extent;
(e) Updating the definition of the domain according to wormhole extent;
(f) Updating the time; and
(g) Iterating as desired from step b).

In another embodiment, a method of optimizing acid treatment of a hydrocarbon containing carbonate reservoir includes
carrying out linear core flood experiments varying one or more parameters selected form the group consisting of acid formulation, rock type, flow rate, and temperature;
deriving the following functions from the experiments, as a function of the parameters:
   Θₒ—the pore volume to wormhole/dissolution front breakthrough; and, if the acid formulation is a self-diverting acid:
      Θᵣ—the pore volume to resistance zone breakthrough; and
      Δpᵣ—the pressure drop at resistance zone breakthrough;
solving the flow of acid from a wellbore segment to a corresponding reservoir layer during a matrix acidizing simulation by a process comprising:
   defining the initial geometry of the domain in which the flow problem is to be solved;
   determining the complex potential associated with the flow problem in the domain under consideration;
   determining streamlines from the complex potential in the domain under consideration;
   using the streamlines to solve flow over a time step δt to propagate acid within the domain and update wormhole extent;
using the simulator in an optimization loop together with known and/or estimated reservoir parameters; and
calculating at least one of the following from the simulator optimization loop:
   stage and rate volumes of the acid treatment;
   fluid selection for the acid treatment;
   wormhole invasion profile; and
   skin profile.
      The simulator is used to model matrix acidizing in the geologic formations of interest. Based on the calculations, treatment conditions can be selected for use in the field to enhance production of oil or gas from the geologic formation.

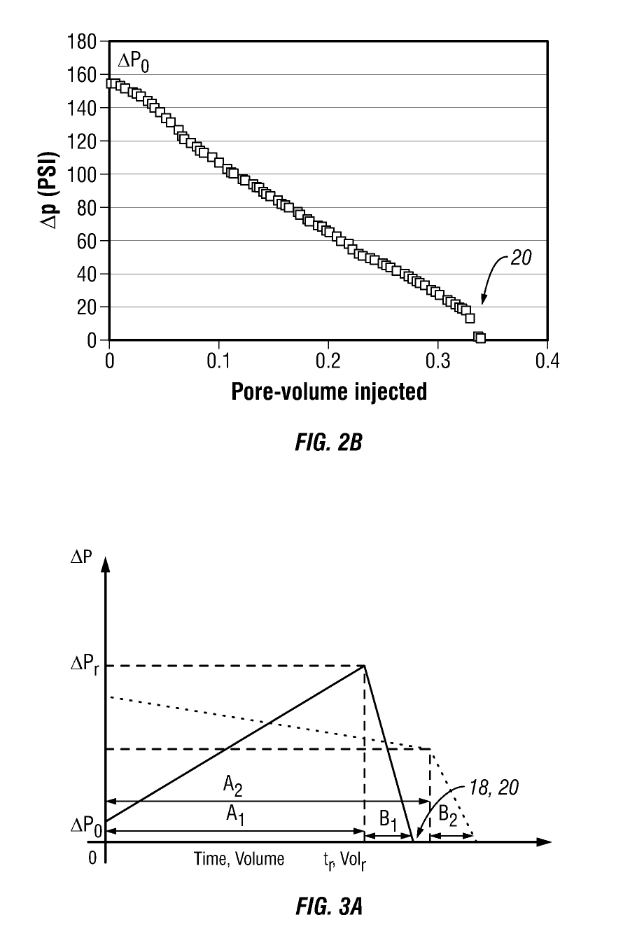

Typically, multiple pressure taps are installed down the length of the core holder; FIG. 1 shows an inlet pressure tap [10], that has an inlet pressure pᵢ, and a second pressure tap [12], that has a pressure away from the inlet p_{L}, at a distance [14], denoted L, from the inlet. The cross sectional area of the core, A, for example at the core face, is shown at [16]. In order to measure pore-volume to breakthrough for a non-self diverting acid, acid is pumped at a constant rate Q and the pressure drop Δp across the core is monitored. The initial pressure drop when the acid reaches the inlet core face is called Δp₀. Then, as acid flows into the core, the pressure drop declines mostly linearly as illustrated in FIG. 2A, in which the breakthrough time, tₒ, is shown at [18], and in FIG. 2B in which the pore-volume to breakthrough, Θ₀, is shown at [20]. When Δp is virtually equal to 0 (i.e., the core permeability has reached a value k_{w} orders of magnitude larger than the initial permeability k₀) the pore-volume injected is recorded as the pore-volume to breakthrough Θ₀.

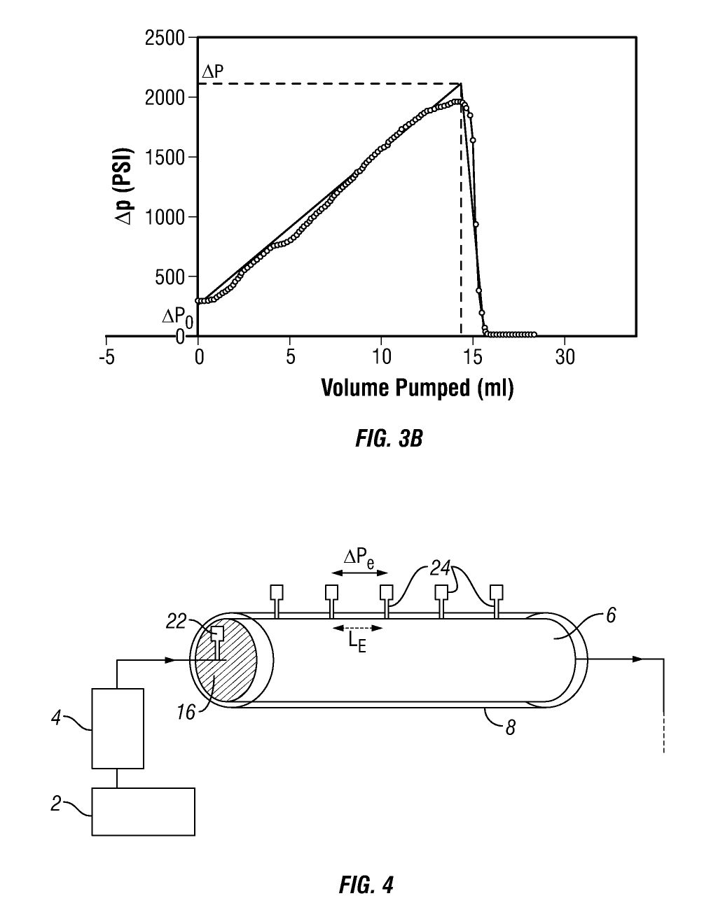

More recently, new acid systems, also known as self-diverting acids such as Viscoelastic Diverting Acid (VDA™), have been used to improve the performance of more classical acid systems such as HCl or organic acids. When such systems are pumped using the same procedure as the one described above, very different Δp behavior can be observed, as is illustrated in FIG. 3. FIG. 3a illustrates the development of Δp with time of pumping (or equivalently, with volume pumped) at a constant rate for two arbitrary systems designated A and B. Results with one self-diverting acid 1, in rock R₁, at temperature T₁, and rate Q₁, are shown by the solid line; results with another self-diverting acid 2, in rock R₂, at temperature T₂, and rate Q₂, are shown by the dotted line.

One important difference is that Δp may increase and then decrease with time or decrease in two regimes at different rates. In particular, it is observed that Δp has a piece-wise linear evolution. First, Δp evolves according to a first linear relationship with time (or equivalently with volume or pore volume injected) in the regions marked as A1 and A2 for two illustrative fluids. Then, at a certain time tᵣ, (or volume Volᵣ) it switches to a second linear behavior, as depicted by B1 and B2 in FIG. 3a. Associated with this behavior, we define two new parameters Δpᵣ (see FIG. 3a) and the number of pore-volumes to reach Δpᵣ, denoted Θᵣ. Δpᵣ is defined as the value of Δp when Δp switches from the first to the second linear trend at time tᵣ. The parameter Θᵣ is given by:

$${Θ}_{r} = \frac{{Vol}_{r}}{PV} = \frac{{Qt}_{r}}{PV} \qquad ( 2 )$$

where PV is the pore volume of the core, measured by known methods to determine the volume of liquid held in the core at saturation.

These two parameters constitute a means of predicting the performance of self-diverting acids when used in mathematical models and algorithms as will be explained below. Real data are shown in FIG. 3b.

Additional experiments have shown that the pressure drop evolution described in FIG. 3, and obtained for self-diverting acid, is due to the existence of a region of low fluid mobility propagating ahead of the wormholes, or ahead of the dissolutions fronts in general. For illustration, a setup as in FIG. 1 is fitted with multiple pressure taps and transducers to measure the pressure along the core during the acid injection experiments, local pressure drops Δpₑ along the core can be measured. Such a new experimental setup is represented in FIG. 4, in which the inlet pressure tap and transducer is shown at [22] and additional pressure taps and transducers at distances down the core holder are shown at [24].

For a given pair of successive transducers (taps), Lₑ is the distance between the two taps, kₑ is the permeability of the core and μₑ is the fluid viscosity between the two taps. According to Darcy's law regarding fluid flow, the measured parameters are interrelated:

$$Q = \frac{{Ak}_{e}}{{μ}_{e}} \frac{Δ {p}_{e}}{{L}_{e}} \qquad ( 3 )$$

where A is the cross sectional area of the core and Q is the rate of fluid flow. The fluid mobility Mₑ is defined as:

$${M}_{e} = \frac{{k}_{e}}{{μ}_{e}} \qquad ( 4 )$$

With the apparatus in FIG. 4, one can:
measure Δpₑ for every pair of transducers, against time,
and use equations (3) and (4) to determine the fluid mobility Mₑ between every pair of transducers, against time

From the knowledge of Mₑ at any time, either an effective viscosity or an effective permeability can also be determined:
assuming the core permeability k₀ is unchanged, equation (4) gives

$${μ}_{e} = \frac{{k}_{0}}{{M}_{e}} \qquad ( 5 )$$

assuming the acid viscosity μ is known, equation (4) gives:

kₑ=μMₑ (6)

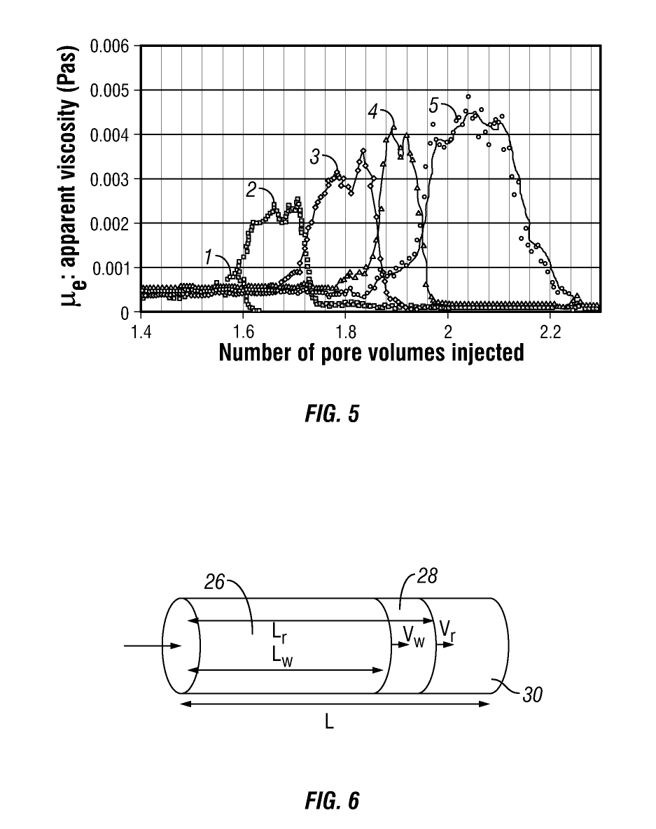

The effective viscosity μₑ of the fluid flowing between pairs of transducers can be monitored against time, or equivalently, against the number of pore volumes injected. The results of one example of such monitoring are illustrated in FIG. 5. The five curves labeled 1, 2, 3, 4, and 5 in FIG. 5 are the values of μₑ calculated from equations (3), (4), and (5) at the five locations Lₑ in FIG. 4.

Line number 1 (see FIG. 5) corresponds to the zone between the core inlet and the first pressure tap on the core. Line number 2 corresponds to the zone between the first and second pressure taps on the core. The other lines represent the remaining successive pairs in order.

From FIG. 5, it can be seen that, as the self-diverting acid flows into the core, a first zone of finite effective viscosity μₑ propagates along the core (observed from the viscosity peaks) followed be a zone of virtually zero effective viscosity, or equivalently (using equation (4)), a zone of very large effective permeability kₑ. The flow pattern in the core when acid is being pumped (from left to right as shown in the figure) can therefore be represented as in FIG. 6.

The zone of high fluid mobility [26] can be parameterized by an effective fluid mobility Mₑ=M_{w} and a propagation velocity V_{w}. Equivalently, the zone can also be characterized by an effective fluid viscosity μ_{w} or an effective permeability k_{w}, derived according to equation (4).

Similarly, the zone of resistance or low fluid mobility [28] can be parameterized by an effective fluid mobility Mₑ=Mᵣ (and therefore according to Equation 4 an effective fluid viscosity μₑ=μᵣ or an effective permeability kₑ=kᵣ), as well as a propagation velocity Vᵣ. Finally, there is a zone of displaced fluid [30] that was originally in the core prior to injection.

The velocities can be determined as follows

$$\{ \begin{matrix}{V}_{w} ( ( Q \text{/} A ) , T , Ro , Ac ) = ( \frac{Q}{A} ) \frac{1}{{θ}_{0} ( ( Q \text{/} A ) , T , Ro , Ac )} \\ {V}_{r} ( ( Q \text{/} A ) , T , Ro , Ac ) = ( \frac{Q}{A} ) \frac{1}{{θ}_{r} ( ( Q \text{/} A ) , T , Ro , Ac )}\end{matrix} \qquad ( 7 )$$

The parentheses indicate that the velocities and pore volumes to breakthrough are themselves functions of fluid velocity Q/A, temperature T, rock formation Ro, and acid formulation Ac. The functions Θ₀ and Θᵣ are determined experimentally from the core flood experiments.

Using effective viscosities to express the effective mobilities, and rearranging the formulae, the effective viscosity μᵣ is given by (8), and the derivation of (8) is given below.

$${μ}_{r} = {μ}_{d} \frac{Δ {p}_{r}}{Δ {p}_{0}} \frac{{Θ}_{0}}{{Θ}_{0} - {Θ}_{r}} \qquad ( 8 )$$

Where μ_{d} is the viscosity of the displaced fluid, originally saturating the core before acid is injected; Δp₀ is the value of the pressure drop across the core when only the displaced fluid is pumped at the same conditions (typically brine). (8) is derived as follows. Let L_{w} be the distance traveled by the wormholes, measured from the core inlet, during the core-flood experiment, where the fluid mobility is M_{w} (see FIG. 6). Let Lᵣ be the distance traveled by the front of low fluid mobility, where the fluid mobility is Mᵣ (see FIG. 6). At the moment when Lᵣ=L, L being the length of the core, Δpᵣ is measured and using Darcy's law, we find that,

$$Δ {p}_{r} = Q \frac{{μ}_{r}}{{Ak}_{0}} ( L - {L}_{w} ) = Q \frac{{μ}_{r}}{{Ak}_{0}} L ( 1 - \frac{{Θ}_{r}}{{Θ}_{0}} ) , \qquad ( 9 )$$

and since, by definition,

$$Δ {p}_{0} = Q \frac{{μ}_{d}}{{Ak}_{0}} L , \qquad ( 10 )$$

we then find (8) by simple algebra.

For the zone of high fluid mobility, we find that the effective fluid viscosity μₑ=μ_{w} in this region can be expressed as:

$${μ}_{w} = {μ}_{d} \frac{Δ {p}_{bt}}{Δ {p}_{0}} \qquad ( 11 )$$

where Δp_{bt} is the value of Δp when the wormholes have broken through the outlet face of the core (this is the final value of Δp). (11) is derived as follows. When, L_{w}=L, L being the length of the core, Δp_{bt} is measured. Using Darcy's law, we then find that,

$$Δ {p}_{bt} = Q \frac{{μ}_{w}}{{Ak}_{0}} L \qquad ( 12 )$$

then, using (10) and (12), we find (11) by simple algebra.

Equivalently, (8) and (11) can be used to define an effective mobility or an effective permeability in each zone, using Equation (4). This leads to equation (13).

$$\{ \begin{matrix}{M}_{r} = \frac{{k}_{0}}{{μ}_{d} \frac{Δ {p}_{r}}{Δ {p}_{0}} \frac{{Θ}_{0}}{{Θ}_{0} - {Θ}_{r}}} \\ {M}_{w} = \frac{{k}_{0}}{{μ}_{d} \frac{Δ {p}_{bt}}{Δ {p}_{0}}}\end{matrix} \{ \begin{matrix}{k}_{r} = \frac{{k}_{0}}{\frac{{μ}_{d}}{μ} \frac{Δ {p}_{r}}{Δ {p}_{0}} \frac{{Θ}_{0}}{{Θ}_{0} - {Θ}_{r}}} \\ {k}_{w} = \frac{{k}_{0}}{\frac{{μ}_{d}}{μ} \frac{Δ {p}_{bt}}{Δ {p}_{0}}}\end{matrix} \qquad ( 13 )$$

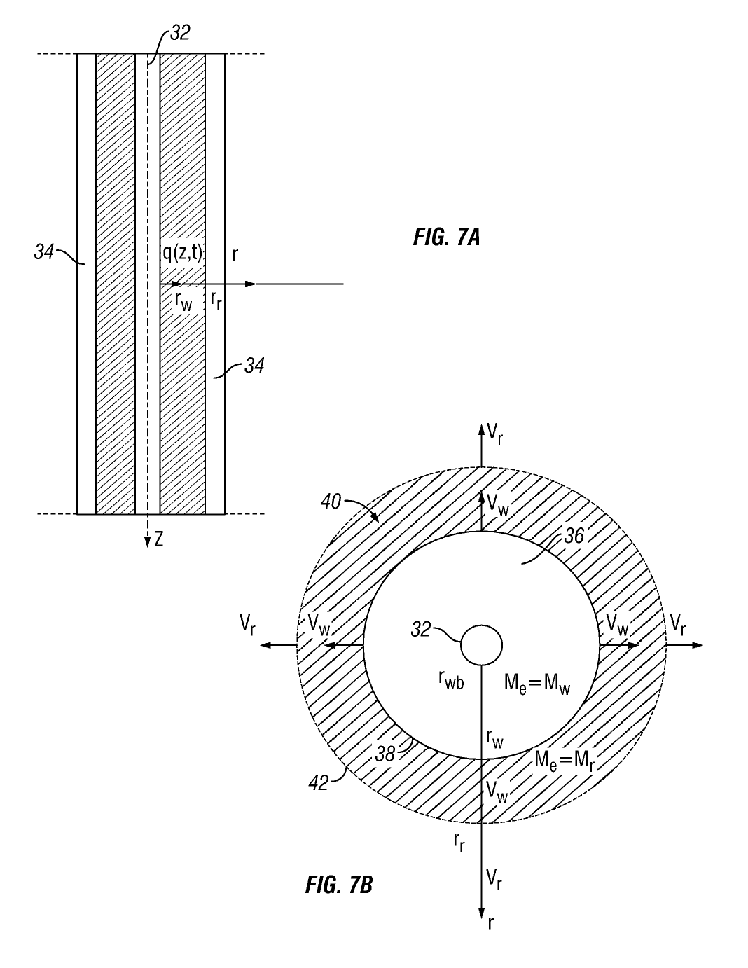

The use of Equations (8) and (11) in the case of axisymmetric radial flow around the wellbore in the reservoir as illustrated in FIGS. 7A and 7B. A wellbore [32] passes through a reservoir [34] and connects first to a wormholed or dissolved zone [36], bounded by a wormhole tip or dissolution front [38], and then to a resistance zone [40], bounded by a resistance zone front [42].

In FIGS. 7A and 7B, q(z,t) is the flow-rate per unit height into the reservoir at a time t, at a distance z along the well-bore. Let r_{w}(z,t) be the radius of the wormhole-tip front or dissolution front and let rᵣ(z,t) be the radius of the front of the resistance zone, both at the same time t and depth z. The evolution with time of both radii is then determined by solving the following set of equations.

$$\begin{matrix}\{ \begin{matrix}\frac{\partial }{\partial t} ( {r}_{w} ( z , t ) ) = \frac{{V}_{w} ( V ( z , {r}_{w} ) , T ( z , {r}_{w} ) , Ro ( z , {r}_{w} ) , Ac ( z , {r}_{w} ) )}{{Φ}_{0} ( z , {r}_{w} )} \\ V ( z , {r}_{w} ) = \frac{q ( z , t )}{2 π {r}_{w} ( z , t )}\end{matrix} & ( 14 ) \\ \{ \begin{matrix}\frac{\partial }{\partial t} ( {r}_{r} ( z , t ) ) = \frac{{V}_{r} ( V ( z , {r}_{r} ) , T ( z , {r}_{r} ) , Ro ( z , {r}_{r} ) , Ac ( z , {r}_{r} ) )}{{Φ}_{0} ( z , {r}_{r} )} \\ V ( z , {r}_{r} ) = \frac{q ( z , t )}{2 π {r}_{r} ( z , t )}\end{matrix} & ( 15 )\end{matrix}$$

Equations (14) and (15) are integrated by numerical means. Solving (14) and (15) allows the tracking of the wormhole tip and low-mobility front, respectively. In order to compute the pressure profile in the treated zone, i.e. at any z and for r between r_{wb} and rᵣ, (r_{wb} is the wellbore radius at the depth z and therefore the pressure in the wellbore during the treatment, we make use of μᵣ as follows:

$$\{ \begin{matrix} V ( z , r , t ) = \frac{q ( z , t )}{2 π r} = - \frac{{k}_{e} ( z , r , t )}{{μ}_{e} ( z , r , t )} \frac{\partial }{\partial r} p ( z , r , t ) \\ {μ}_{e} ( z , r , t ) = \{ \begin{matrix}μ & if {r}_{wb} ( z ) < r < {r}_{w} ( z , t ) \\ {μ}_{r} & if {r}_{w} ( z , t ) < r < {r}_{r} ( z , t )\end{matrix} \\ {k}_{e} ( z , r , t ) = \{ \begin{matrix}{k}_{w} & if {r}_{wb} ( z ) < r < {r}_{w} ( z , t ) \\ {k}_{0} & if {r}_{w} ( z , t ) < r\end{matrix}\end{matrix} \qquad ( 16 )$$

Equations (14)-(16) are integrated by analytical or numerical means and allow calculation of the pressure drop between the wellbore and rᵣ, anywhere along the wellbore. The pressure at the wellbore p(z,r_{wb},t) can be determined from the pressure p(z,rᵣ,t) at the resistance front using the following formula.

$$\{ \begin{matrix}p ( z , {r}_{wb} , t ) = p ( z , {r}_{w} , t ) + ln ( \frac{{r}_{w}}{{r}_{wb}} ) \frac{q ( z , t ) μ}{2 π {k}_{w}} \\ p ( z , {r}_{w} , t ) = p ( z , {r}_{r} , t ) + ln ( \frac{{r}_{r}}{{r}_{w}} ) \frac{q ( z , t ) {μ}_{r}}{2 π {k}_{0}}\end{matrix} \qquad ( 17 )$$

### In (16) and (17), it is possible to substitute the effective viscosity μᵣ and the effective permeability k_{w} with other combinations giving rise to the same fluid mobility, for instance, (16) is equivalent to (18) and (17) to (19).

$$\begin{matrix}\{ \begin{matrix}V ( z , r , t ) = \frac{q ( z , t )}{2 π r} = - M ( z , r , t ) \frac{\partial }{\partial r} p ( z , r , t ) \\ M ( z , r , t ) = \{ \begin{matrix}{M}_{w} & if {r}_{wb} ( z ) < r < {r}_{w} ( z , t ) \\ {M}_{r} & if {r}_{w} ( z , t ) < r < {r}_{r} ( z , t )\end{matrix}\end{matrix} & ( 18 ) \\ \{ \begin{matrix}p ( z , {r}_{wb} , t ) = p ( z , {r}_{w} , t ) + ln ( \frac{{r}_{w}}{{r}_{wb}} ) \frac{q ( z , t )}{2 π {M}_{w}} \\ p ( z , {r}_{w} , t ) = p ( z , {r}_{r} , t ) + ln ( \frac{{r}_{r}}{{r}_{w}} ) \frac{q ( z , t )}{2 π {M}_{r}}\end{matrix} & ( 19 )\end{matrix}$$

For the case of non-axisymmetric flow, whether for a self-diverting acid or a non-self-diverting acid, the following are considered. First criteria are developed to predict when flow is essentially axisymmetric and can thus be approximated accurately with a simple axisymmetric model. Next, a general method of modeling non-axisymmetric flow is provided that is applicable to both kinds of acids.

The velocity field observed during fluid flow in porous media is known to obey Darcy's law:

$$\{ \begin{matrix} \vec{V} ( t , x , y , z ) = - K ( x , y , z ) \frac{\vec{∇} p ( t , x , y , z )}{μ} \\ K ( x , y , z ) = [ \begin{matrix}{k}_{xx} ( x , y , z ) & {k}_{xy} ( x , y , z ) & {k}_{xz} ( x , y , z ) \\ {k}_{yx} ( x , y , z ) & {k}_{yy} ( x , y , z ) & {k}_{yz} ( x , y , z ) \\ {k}_{zx} ( x , y , z ) & {k}_{zy} ( x , y , z ) & {k}_{zz} ( x , y , z )\end{matrix} ]\end{matrix} \qquad ( 20 )$$

where

\vec{V} is the Darcy velocity of the fluid in the matrix;

μis the viscosity of fluid saturating the matrix

p is the pressure in the fluid;

K is the permeability tensor

When the x-axis and the y-axis are contained within the bedding plane of the rock formation, and assuming that for a given depth z, the permeability of the rock does not vary within a plane parallel to the bedding plane, the permeability tensor K is often simplified to the following expression.

$$K ( x , y , z ) = [ \begin{matrix}{k}_{h} ( z ) & 0 & 0 \\ 0 & {k}_{h} ( z ) & 0 \\ 0 & 0 & {k}_{v} ( z )\end{matrix} ] \qquad ( 21 )$$

kₕ is known as the horizontal permeability

kᵥ is known as the vertical permeability

The horizontal permeability kₕ and the vertical permeability kᵥ are classical petrochemical properties of a rock formation. They are conventionally measured during core flood experiments or from logs.

From (20) and (21), the velocity vector of the fluid flowing from the wellbore into the rock, at a depth z, will have three components, Vₓ, V_{y} and V_{z}.

$${V}_{x} = - \frac{{k}_{h}}{μ} \frac{\partial p}{\partial x} \\ {V}_{y} = - \frac{{k}_{h}}{μ} \frac{\partial p}{\partial y} \\ {V}_{z} = - \frac{{k}_{v}}{μ} \frac{\partial p}{\partial z} \qquad ( 22 )$$

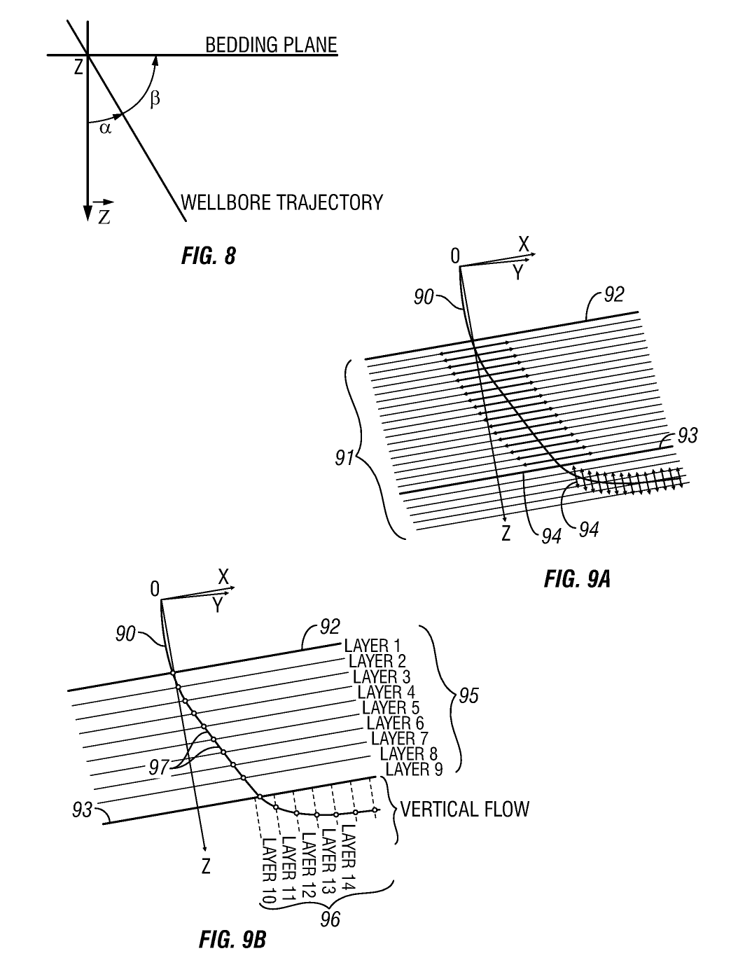

We assume that the wellbore trajectory forms an angle denoted β with the bedding plane at depth z, as illustrated in FIG. 8.

Since the pressure gradient along the wellbore is always small compared to the pressure gradients perpendicular to the wellbore, we find,

$$\{ \begin{matrix} \begin{matrix}{v}_{h} ( r = {r}_{wb} ) = \sqrt{{V}_{x}^{2} ( r = {r}_{wb} ) + {V}_{y}^{2} ( r = {r}_{wb} )} \\ = \vert cos ( α ) \frac{{k}_{h}}{μ} \frac{\partial p}{\partial r} ( r = {r}_{wb} ) \vert\end{matrix} \\ \begin{matrix}{v}_{v} ( r = {r}_{wb} ) = \vert {V}_{z} \vert ( r = {r}_{wb} ) \\ \vert sin ( α ) \frac{{k}_{h}}{μ} \frac{\partial p}{\partial r} ( r = {r}_{wb} ) \vert\end{matrix}\end{matrix} \qquad ( 23 )$$

where,

α is the angle between the wellbore trajectory and the downwards normal to the bedding plane: α+β=π2

r is the radial distance away from the wellbore center

r_{wb} is the wellbore radius

vₕ is the modulus of the velocity vector (Vₓ,V_{y})

vᵥ is the absolute value of V_{z}, the vertical component of velocity vector

According to (23), it is possible to derive a criterion to determine whether the flow will take place mostly in planes parallel to the bedding or in planes perpendicular to the bedding.

$$\{ \begin{matrix}{v}_{h} > ⇔ \frac{{k}_{h}}{{k}_{v}} > \vert tan ( α ) \vert \\ {v}_{h} < ⇔ \frac{{k}_{h}}{{k}_{v}} < \vert tan ( α ) \vert\end{matrix} \qquad ( 24 )$$

Therefore, knowing kₕ, kᵥ and α, it is possible to determine in which proportions the flow splits between the horizontal direction (i.e. within a plane parallel to the bedding plane) and the vertical one.
1. If kᵥ=kₕ, at depth z, the flow is contained within a plane perpendicular to wellbore trajectory, the permeability is constant within the plane and the flow is axisymmetric within the plane: radial flow model can be used in such planes;
2. If kᵥ≠kₕ and kₕ>kᵥ tan(α), the flow is mostly in the bedding plane intercepting the well trajectory at the considered depth z, the flow is axisymmetric within the plane since the permeability is isotropic (kₓ=k_{y}=kₕ) and assumed constant within the plane: radial flow model can be used in such planes; and
3. If kᵥ≠kₕ and kₕ<kᵥ tan(α), the flow is mostly in the plane perpendicular to the bedding planes, intercepting the well trajectory at the considered depth z and, the flow is not axisymmetric within this plane: radial flow model cannot be used in such planes.

In the following, we describe a method to predict the flow around the wellbore when it is not axisymmetric. Examples of conditions giving rise to such flow include:
1. The flow is not in the bedding plane and at least one of the following conditions is true:
   a. kᵥ is not equal to kₕ
   b. the flow is confined: limited by an upper flow barrier and/or a lower flow barrier (such barriers are common features in geology and usually define the top and bottom of production zones)
2. The flow is in the bedding plane and the flow is confined due to the presence of a flow barrier in a plane perpendicular to the bedding plane (such barriers can be associated with impermeable fractures or faults in geology).

Before solving the flow, the wellbore trajectory is first discretized in multiple segments. For each segment, we defined a layer in the reservoir such that:
If criterion (24) says that the flow is mostly parallel to the bedding plane, the layer corresponding to the given segment is a slice formed by the plane parallel to the bedding plane intersecting the segment at its top (low value of z) and the plane parallel to the bedding plane intersecting the segment at its bottom (large value of z). The flow from the given wellbore segment into the reservoir will then be contained into the above slice
If criterion (24) says that the flow is mostly perpendicular to the bedding plane, the layer corresponding to the given segment is a slice formed by the plane perpendicular to the bedding plane intersecting the segment at its top (low value of z) and the plane perpendicular to the bedding plane intersecting the segment at its bottom (large value of z). The flow from the given wellbore segment into the reservoir will then be contained into the above slice. The flow may be constrained by an upper and/or a lower impermeable flow barrier.

The above segmentation and layering is illustrated in FIG. 9. FIG. 9a shows a well bore trajectory [90] traversing a series of bedding planes [91] across impermeable barriers [92] and [93]. Flow lines [94] indicate horizontal or vertical flow. FIG. 9b shows regions of horizontal and vertical flow discretized into horizontal layers [95] and vertical layers [96] corresponding to wellbore segments [97].

The method for solving the flow between a wellbore segment and the corresponding reservoir layer is divided in several steps. In the following, we illustrate the method in condition 1a or 1b.

For a given segment-layer pair:
a) Define initial geometry of the domain in which the flow problem is to be solved
b) Determine the complex potential associated with the flow problem in the domain under consideration
c) Determine streamlines from the complex potential in the domain under consideration
d) Use streamlines to solve flow over a time step δt and propagate acid within the domain and update wormhole extent
e) Update definition of the domain according to wormhole extent
f) Update time
g) Go back to point b).

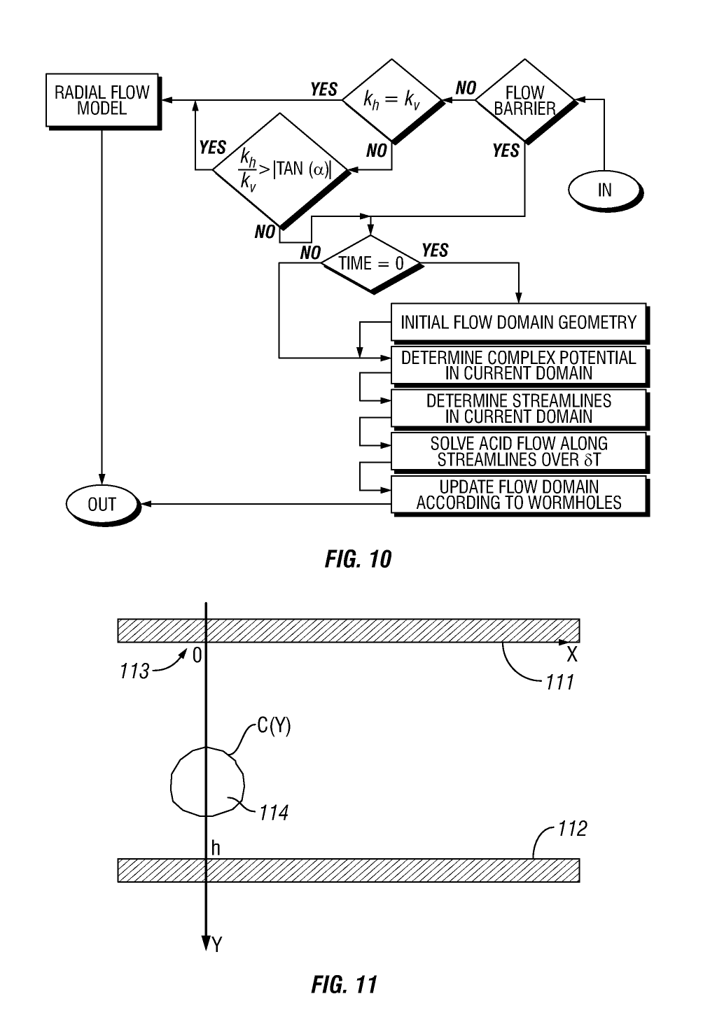

According to criterion (24) and to the above, it is possible to derive a workflow for solving the flow of acid around the wellbore, in the reservoir layer corresponding to the wellbore segment under consideration. This workflow is illustrated in FIG. 10. In this workflow, a flow barrier is defined as any geological feature through which flow cannot occur, and which will change the trajectory of the streamlines when compared to the case where the barrier would have been absent. Such features include:
Impermeable layers
Impermeable faults, fractures and fissures

### We assume that these features have an infinite extent in a given layer and, if more than one occurs in a given layer, they are parallel to each other.

### Step a)—Define Initial Geometry:

In this case, the (x,y) plane is chosen to be perpendicular to the bedding plane and perpendicular to the plane formed by the wellbore trajectory. The problem consists of solving the flow of acid around the wellbore, in the considered reservoir. We assume the existence of an upper and lower flow barrier as described in FIG. 11.

The origin [113] of the y-axis is placed on the upper flow-barrier [111], we note h is the value of y at which the lower flow barrier [112] crosses the y-axis. We note (C(y),y) defines the contour of the wellbore [114] in the (x>0,y) semi-plane.

The initial flow field is determined by solving the following problem, resulting from Darcy's law and assuming incompressible single-phase flow:

$$∇ \cdot ( μ \overline{V} ) = ∇ \cdot ( K \vec{∇} p ) = {k}_{x} \frac{{\partial }^{2} p}{\partial {x}^{2}} + {k}_{y} \frac{{\partial }^{2} p}{\partial {y}^{2}} = 0 \\ \frac{\partial p}{\partial y} ( x , 0 ) = \frac{\partial p}{\partial y} ( x , h ) = 0 \\ p ( \pm C ( y ) , y ) = {p}_{wb} \qquad ( 25 )$$

p_{wb}, is the wellbore pressure in the wellbore segment under consideration, a function of time only in any segment. The x and y variable are rescaled as follows

$$X = x , Y = y \sqrt{\frac{{k}_{x}}{{k}_{y}}} \qquad ( 26 )$$

Using the new rescaled variables, the problem becomes

$$\{ \begin{matrix}\frac{{\partial }^{2} p}{\partial {X}^{2}} + \frac{{\partial }^{2} p}{\partial {Y}^{2}} = 0 \\ \frac{\partial p}{\partial Y} ( X , 0 ) = \frac{\partial p}{\partial Y} ( X , H = h \sqrt{\frac{{k}_{x}}{{k}_{y}}} ) = 0 \\ p ( \pm C ( Y \sqrt{\frac{{k}_{y}}{{k}_{x}}} ) , Y ) = {p}_{wb}\end{matrix} \qquad ( 27 )$$

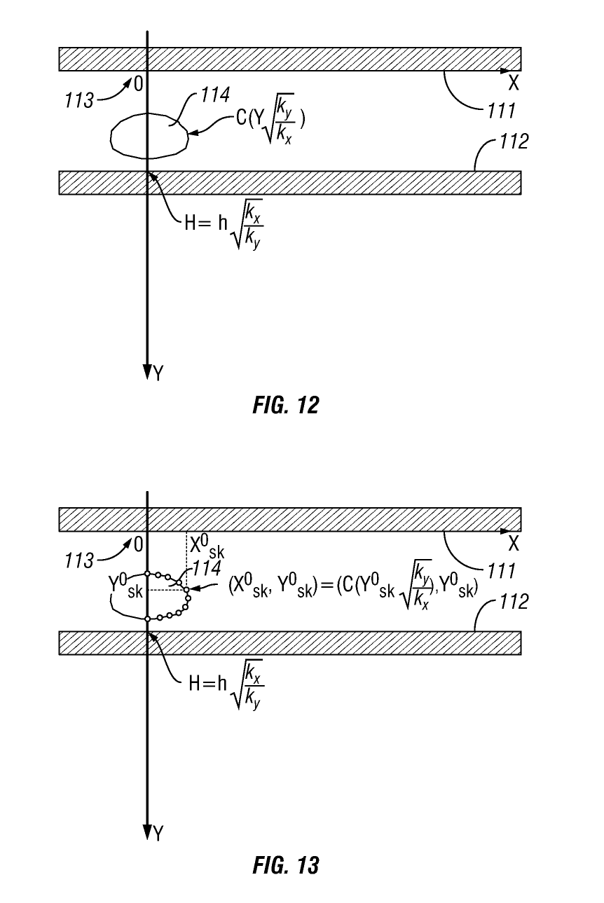

The domain, in the new rescaled (X,Y) plan, is illustrated in FIG. 12.

### Step b)—Determine the Complex Potential:

Problem (27) can be solved using the complex potential theory. We now illustrate one way to determine the complex potential associated to (27).

The complex potential for a source point located, in the complex plane, at ζₛ=Xₛ+iYₛ is:

P(ζ)=ln(ζ−ζₛ) (28)

### Optionally, equation (28) contains a proportionality constant.

Let S⁺ be a set of source points evenly distributed along the contour C (see FIG. 13).

$${S}^{+} = \{ {ζ}_{s 1}^{0 +} , … , {ζ}_{sk}^{0 +} , … , {ζ}_{sN}^{0 +} \} where {ζ}_{sk}^{0 +} = {X}_{sk}^{0} + i {Y}_{sk}^{0} = C ( {Y}_{sk}^{0} \sqrt{\frac{{k}_{y}}{{k}_{x}}} ) + i {Y}_{sk}^{0} \qquad ( 29 )$$

Let S⁻ be the set of points associated with the symmetric of C to the Y-axis:

$${S}^{-} = \{ {ζ}_{s 1}^{0 -} , … , {ζ}_{sk}^{0 -} , … , {ζ}_{sN}^{0 -} \} where {ζ}_{sk}^{0 -} = - {X}_{sk}^{0} + i {Y}_{sk}^{0} = - C ( {Y}_{sk}^{0} \sqrt{\frac{{k}_{y}}{{k}_{x}}} ) + i {Y}_{sk}^{0} \qquad ( 30 )$$

The complex potential Π_{N}⁰ associated with the set (S⁺ U S⁻) of source points is:

$${Π}_{N}^{0} ( ζ ) = {\sum }_{k = 1 , N} ⌊ ln ( ζ - {ζ}_{sk}^{0 +} ) + ln ( ζ - {ζ}_{sk}^{0 -} ) ⌋ \qquad ( 31 )$$

The complex potential Π⁰ associated with the union of C and its symmetric acting as a source line is

$${Π}^{0} ( ζ ) = {lim}_{N \to ∞} {Π}_{N}^{0} ( ζ ) . \qquad ( 32 )$$

At this stage, the domain in which the potential Π⁰ is to be calculated is an unbounded plane (X,Y). In order to introduce the flow barriers located at Y=0 and Y=H, we introduce mirror images of Π⁰ according to the Y=0 and Y=H axis. First, we note \tilde{Π}⁰ the complex potential corresponding to the symmetric of C according to the Y=0 axis and build the following source point sets:

$$\begin{matrix}{\tilde{S}}^{+} = \{ {\tilde{ζ}}_{s 1}^{0 +} , … , {\tilde{ζ}}_{sk}^{0 +} , … , {\tilde{ζ}}_{sN}^{0 +} \} where {\tilde{ζ}}_{sk}^{0 +} = {\tilde{X}}_{sk}^{0} - i {\tilde{Y}}_{sk}^{0} = C ( {\tilde{Y}}_{sk}^{0} \sqrt{\frac{{k}_{y}}{{k}_{s}}} ) - i {\tilde{Y}}_{sk}^{0} & ( 33 ) \\ {\tilde{S}}^{-} = \{ {\tilde{ζ}}_{s 1}^{0 -} , … , {\tilde{ζ}}_{sk}^{0 -} , … , {\tilde{ζ}}_{sN}^{0 -} \} where {\tilde{ζ}}_{sk}^{0 -} = {\tilde{X}}_{sk}^{0} - i {\tilde{Y}}_{sk}^{0} = C ( {\tilde{Y}}_{sk}^{0} \sqrt{\frac{{k}_{y}}{{k}_{s}}} ) + i {\tilde{Y}}_{sk}^{0} & ( 34 )\end{matrix}$$

We find the final complex potential Π:

$$\begin{matrix}Π ( ζ ) = {\sum }_{j = - ∞}^{+ ∞} [ {Π}^{j} ( ζ ) + {\tilde{Π}}^{j} ( ζ ) ] & ( 35 ) \\ {Π}^{j} ( ζ ) = {lim}_{N \to ∞} {Π}_{N}^{j} ( ζ ) {\tilde{Π}}^{j} ( ζ ) = {lim}_{N \to ∞} {\tilde{Π}}_{N}^{j} ( ζ ) & ( 36 ) \\ {\tilde{Π}}_{N}^{j} ( ζ ) = {\sum }_{k = 1 , N} [ ln ( ζ - {ζ}_{sk}^{j +} ) + ln ( ζ - {ζ}_{sk}^{j -} ) ] {\tilde{Π}}_{N}^{j} ( ζ ) = {\sum }_{k = 1 , N} [ ln ( ζ - {\tilde{ζ}}_{sk}^{j +} ) + ln ( ζ - {\tilde{ζ}}_{sk}^{j -} ) ] & ( 37 ) \\ {ζ}_{sk}^{j \pm } = \pm {X}_{sk}^{j} + i {Y}_{sk}^{j} = \pm C ( {Y}_{sk}^{0} \sqrt{\frac{{k}_{y}}{{k}_{x}}} ) + i {Y}_{sk}^{j} {Y}_{sk}^{j} = 2 j H + {Y}_{sk}^{0} & ( 38 ) \\ {\tilde{ζ}}_{sk}^{j \pm } = \pm {\tilde{X}}_{sk}^{j} + i {\tilde{Y}}_{sk}^{j} = \pm C ( {Y}_{sk}^{0} \sqrt{\frac{{k}_{y}}{{k}_{x}}} ) + i {\tilde{Y}}_{sk}^{j} {\tilde{Y}}_{sk}^{j} = 2 j H - {Y}_{sk}^{0} & ( 39 )\end{matrix}$$

By definition, the components V_{X} and V_{Y} of the flow velocity vector \vec{V} in the (X,Y) plane are:

$${V}_{X} ( ζ ) = Re [ \frac{\partial Π}{\partial ζ} ( ζ ) ] \\ {V}_{Y} ( ζ ) = - Im [ \frac{\partial Π}{\partial ζ} ( ζ ) ] \qquad ( 40 )$$

By calculating the complex derivatives of the complex potential Π, one finds:

$$\begin{matrix}{V}_{X} ( ζ ) = {\sum }_{j = - ∞}^{+ ∞} {V}_{X}^{+} ( ζ ) + {V}_{X}^{-} ( ζ ) \\ {V}_{X}^{+} ( ζ ) = {lim}_{N \to ∞} [ {\sum }_{k = 1}^{N} ( \begin{matrix}\frac{X - {X}_{sk}^{j}}{{( X - {X}_{sk}^{j} )}^{2} {( Y - {Y}_{sk}^{j} )}^{2}} + \\ \frac{X - {\tilde{X}}_{sk}^{j}}{{( X - {\tilde{X}}_{sk}^{j} )}^{2} + {( Y - {\tilde{Y}}_{sk}^{j} )}^{2}}\end{matrix} ) ] \\ {V}_{X}^{-} ( ζ ) = {lim}_{N \to ∞} [ {\sum }_{k = 1}^{N} ( \begin{matrix}\frac{X + {X}_{sk}^{j}}{{( X + {X}_{sk}^{j} )}^{2} + {( Y - {Y}_{sk}^{j} )}^{2}} + \\ \frac{X + {\tilde{X}}_{sk}^{j}}{{( X + {\tilde{X}}_{sk}^{j} )}^{2} + {( Y - {\tilde{Y}}_{sk}^{j} )}^{2}}\end{matrix} ) ] \\ and & ( 41 ) \\ {V}_{Y} ( ζ ) = {\sum }_{j = - ∞}^{+ ∞} {V}_{Y}^{+} ( ζ ) + {V}_{Y}^{-} ( ζ ) \\ {V}_{Y}^{+} ( ζ ) = {lim}_{N \to ∞} [ {\sum }_{k = 1}^{N} ( \begin{matrix}\frac{Y - {Y}_{sk}^{j}}{{( X - {X}_{sk}^{j} )}^{2} + {( Y - {Y}_{sk}^{j} )}^{2}} + \\ \frac{Y - {\tilde{Y}}_{sk}^{j}}{{( X - {\tilde{X}}_{sk}^{j} )}^{2} - {( Y - {\tilde{Y}}_{sk}^{j} )}^{2}}\end{matrix} ) ] \\ {V}_{Y}^{-} ( ζ ) = {lim}_{N \to ∞} [ {\sum }_{k = 1}^{N} ( \begin{matrix}\frac{Y - {Y}_{sk}^{j}}{{( X + {X}_{sk}^{j} )}^{2} + {( Y - {Y}_{sk}^{j} )}^{2}} + \\ \frac{Y - {\tilde{Y}}_{sk}^{j}}{{( X + {\tilde{X}}_{sk}^{j} )}^{2} + {( Y - {\tilde{Y}}_{sk}^{j} )}^{2}}\end{matrix} ) ] & ( 42 )\end{matrix}$$

### Step c)—Determine Streamlines from the Complex Potential:

For any pair of coordinates (X,Y), one can compute the velocity vector in the (X,Y) plane using Equations (41) and (42). From the knowledge of the velocity vector at any point, streamlines can be computed solving the streamline equation:

V_{X}δY=V_{Y}δX (43)

For building the streamlines, one method consists of choosing a small value for a displacement step δ along the streamline. The origin of a given streamline is a point (X,Y) on the wellbore contour. Then there are 2 cases:
If V_{X} is larger than V_{Y} in absolute value, then we take δX=δ and, knowing V_{X} and V_{Y} at (X,Y), the displacement (δX,δY) along the streamline can be computed by calculating δY from Equation (43), and a new point is determined on the streamline: (X+δX,Y+δY)
If V_{Y} is larger than V_{X} in absolute value, then we take δY=δ and, knowing V_{X} and V_{Y} at (X,Y), the displacement (δX,δY) along the streamline can be computed by calculating δX from Equation (43)), and a new point is determined on the streamline: (X+δX,Y+δY)

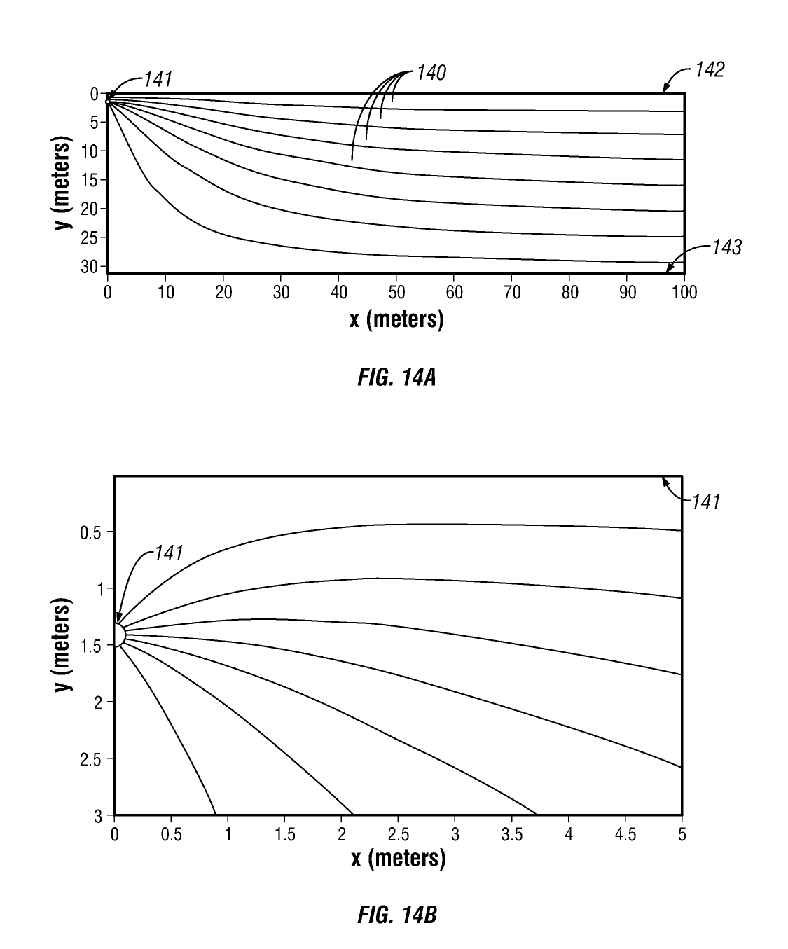

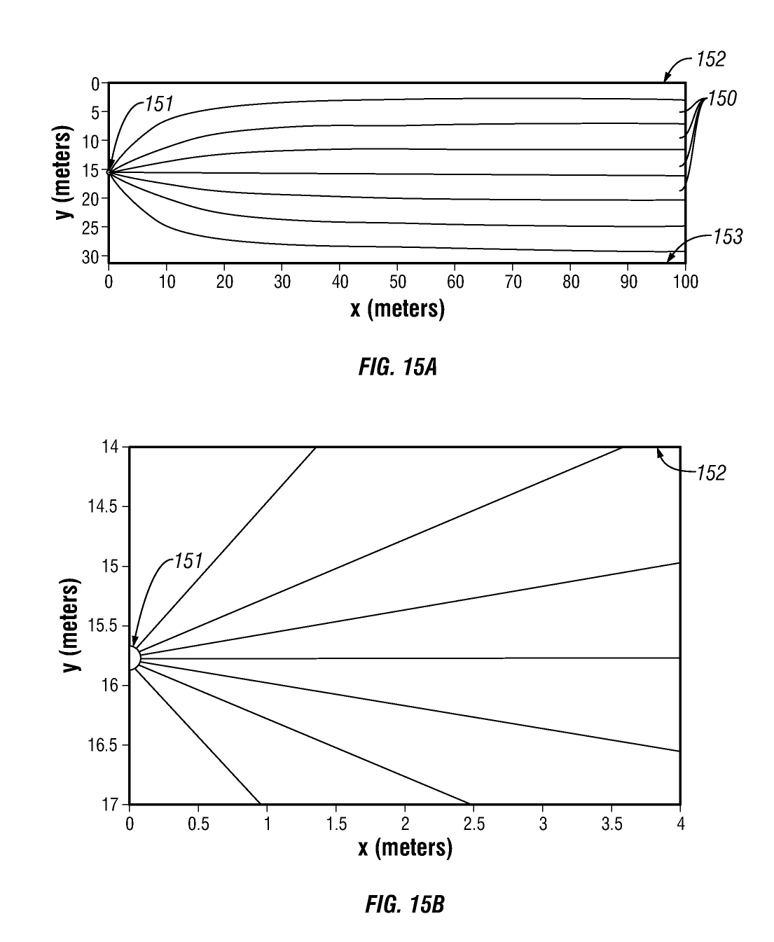

By iterating the above, any streamline originating from a point on the wellbore contour can be drawn. The streamlines in the original (x,y) plane can be obtained from the streamlines in the (X,Y) plane by re-scaling the coordinates using Equation (26). FIGS. 14 and 15 illustrate streamlines computed using the above method. FIG. 14a shows a set of streamlines [140] computed with a permeability ratio kₕ/kᵥ=5. The wellbore is located at 1.4 m from the top (y=0) impermeable barrier [142]. Another impermeable barrier [143] is located at the bottom y=h=31.8 m. FIG. 14b is a zoom of FIG. 14a around the wellbore. FIG. 15a shows a set of streamlines [150] computed with a permeability ratio kₕ/kᵥ=5. The wellbore [151] is located at 15.75 m from the top (y=0) impermeable barrier [152]. Another impermeable barrier [153] is located at the bottom y=h=31.8 m. FIG. 15b is a zoom of FIG. 15a around the wellbore.

### Step d)—Use Streamlines to Solve Flow

Once the streamlines are computed, acid flow is solved along the streamlines. In the following, we develop a method based on the finite-volume technique to solve flow along streamlines.

The Darcy velocity at any point and time in the (x,y) plane can be obtained from Darcy's law:

$$\{ \begin{matrix}\vec{V} ( x , y ) = - KM ( x , y ) \vec{∇} p ( x , y ) \\ K = ( \begin{matrix}{k}_{x} & 0 \\ 0 & {k}_{y}\end{matrix} )\end{matrix} \qquad ( 44 )$$

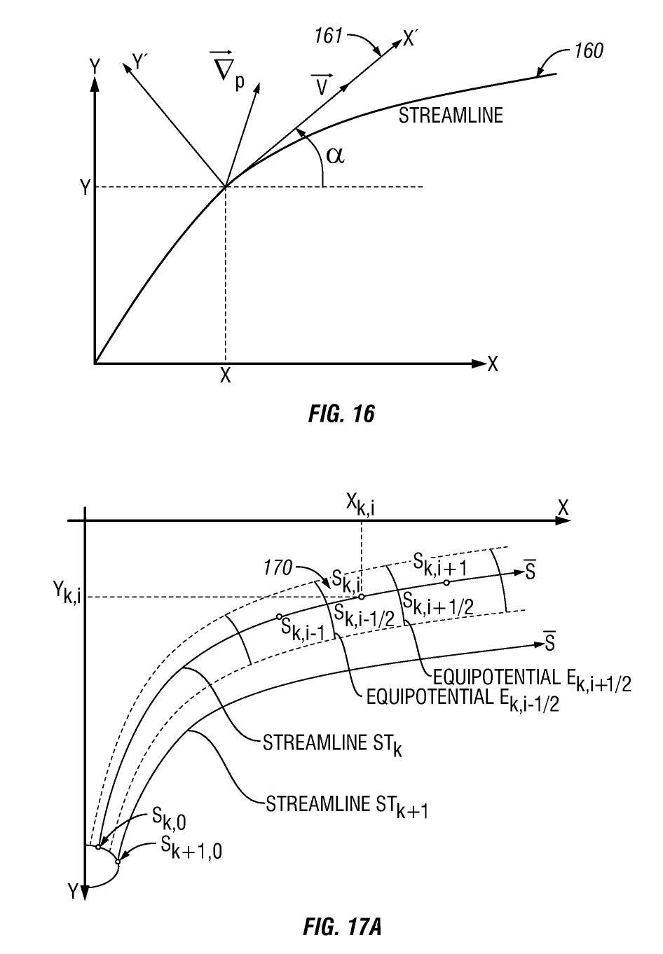

M is the fluid mobility. We now develop a finite-volume approach to solve (44). Referring to FIG. 16, consider the streamline [160] passing through point (x,y) and \vec{V} the Darcy velocity at this point. We note (x′,y′) defines the coordinate system [161] where the x′-axis is in the direction of \vec{V}, as illustrated in FIG. 16. In this coordinate system, we have the following relationships:

$$\{ \begin{matrix}\vec{V} = {( \begin{matrix}‖ \vec{V} ‖ \\ 0\end{matrix} )}_{( {x}^{′} , {y}^{′} )} = {( \begin{matrix}\sqrt{{u}^{2} + {v}^{2}} \\ 0\end{matrix} )}_{( {x}^{′} , {y}^{′} )} \\ \vec{∇} p = {( \begin{matrix}\frac{\partial p}{\partial {x}^{′}} \\ \frac{\partial p}{\partial {y}^{′}}\end{matrix} )}_{( {x}^{′} , {y}^{′} )} - \frac{1}{M} \frac{1}{‖ \vec{V} ‖} {( \begin{matrix}\frac{{u}^{2}}{{k}_{x}} + \frac{{v}^{2}}{{k}_{y}} \\ \frac{uv}{{k}_{x}} - \frac{uv}{{k}_{y}}\end{matrix} )}_{( {x}^{′} , {y}^{′} )}\end{matrix} \qquad ( 45 )$$

Therefore, the velocity along the streamline [160] can be determined from the knowledge of the pressure gradient along the streamline using the effective permeability along the streamline noted k′:

$$\{ \begin{matrix}{\vec{V} ( \begin{matrix}‖ \vec{V} ‖ \\ 0\end{matrix} )}_{( {x}^{′} , {y}^{′} )} = {( \begin{matrix}- {k}^{′} {M}_{( {x}^{′} , {y}^{′} )} \frac{\partial p}{\partial {x}^{′}} \\ 0\end{matrix} )}_{( {x}^{′} , {y}^{′} )} \\ {k}^{′} = \frac{1}{\frac{{cos}^{2} ( α )}{{k}_{x}} + \frac{{sin}^{2} ( α )}{{k}_{y}}}\end{matrix} \qquad ( 46 )$$

The angle α can be determined when the streamline is computed using Equation (43):

$$\{ \begin{matrix}cos ( α ) = \frac{δ x}{\sqrt{{( δ x )}^{2} + {( δ y )}^{2}}} \\ sin ( α ) = \frac{δ y}{\sqrt{{( δ x )}^{2} + {( δ y )}^{2}}}\end{matrix} and δ y = δ Y \sqrt{\frac{{k}_{x}}{{k}_{y}}} and δ x = δ X \qquad ( 47 )$$

One can now compute the flow velocity along the streamline from the component of the pressure gradient along the streamline and from the effective permeability along the streamline using Equation (46). In order to compute the pressure distribution along each streamline, we first consider a set Sₖ of points along the streamline identified by the index k, denoted Stₖ, originating from the following point. This set of points will be used to discretize the streamline in order to apply a finite-volume method to solve the flow along them:

$$\begin{matrix}{s}_{k , 0} = ( {x}_{sk}^{0} , {y}_{sk}^{0} ) = ( C ( {y}_{sk}^{0} ) , {y}_{sk}^{0} ) \\ and & ( 48 ) \\ {S}_{k} = \{ {s}_{k , 0} , {s}_{k , 1} , … , {s}_{k , m} \} \\ {s}_{k , i} = ( {x}_{k , i} , {y}_{k , i} ) \\ ( {x}_{k , 0} , {y}_{k , 0} ) = ( {x}_{sk}^{0} , {y}_{sk}^{0} ) & ( 49 )\end{matrix}$$

Let s̅ be the curvilinear distance along the streamline Stₖ with origin s_{k,0}. The points along streamline Stₖ can be identified through their streamline coordinate. The definition of Sₖ in (49) is equivalent to (50):

$${S}_{k} = \{ {\overline{s}}_{k , 0} , {\overline{s}}_{k , 1} , … , {\overline{s}}_{k , m} \} \\ {\overline{s}}_{k , 0} = 0 \qquad ( 50 )$$

For each pair ( s̅_{k,i}, s̅_{k,i+1}) of point along streamline Stₖ, we defined an interface point s̅_{k,i+1/2} on the streamline such that

s̅_{k,i+1/2}ε] s̅_{k,i}, s̅_{k,i+1}[ (51)

For instance, one can choose the mid-distance between s̅_{k,i} and s̅_{k,i+1}:

$${\overline{s}}_{k , i + 1 / 2} = \frac{1}{2} ( {\overline{s}}_{k , i} + {\overline{s}}_{k , i + 1} ) \qquad ( 52 )$$

Additionally, we consider the streamlines St_{k+1/2} originating from points denoted

(x_{sk+1/2}⁰,y_{sk+1/2}⁰)=(C(y_{sk+1/2}⁰),y_{sk+1/2}⁰) (53)

such that

y_{sk+1/2}⁰=]yₛₖ⁰,yₛₖ₊₁⁰[ (54)

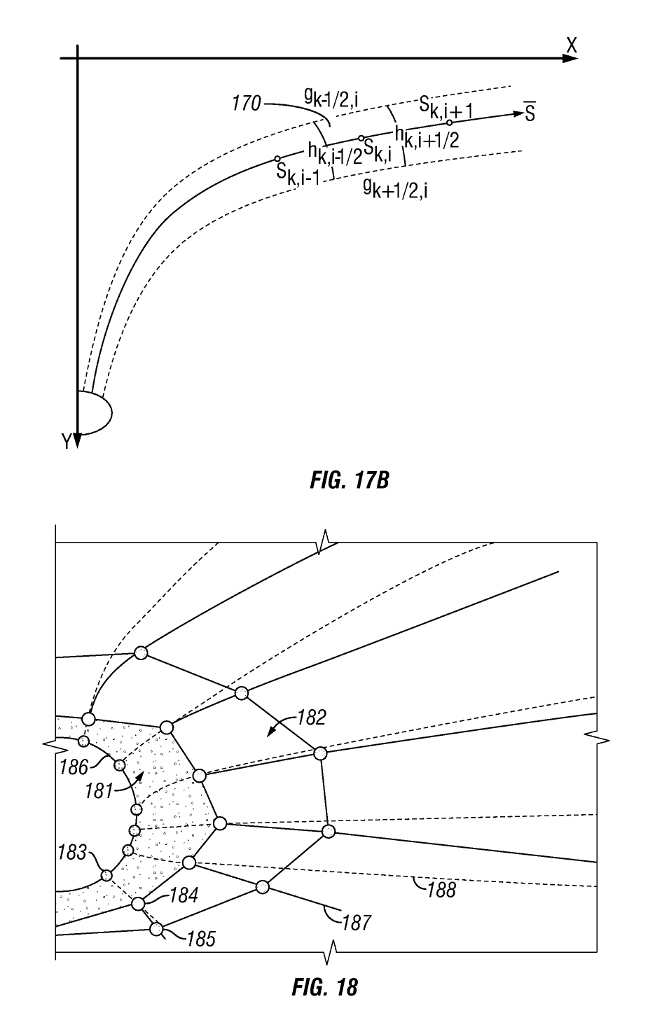

We can now define a control volume [170] (see FIGS. 17a and 17b) around a point s̅_{k,i} on streamline Stₖ, as one would do in order to apply the finite-volume technique. We consider the curve E_{k,i+1/2} intersecting Stₖ at s̅_{k,i+1/2} and intersecting all other possible streamlines located between St_{k-1/2} and St_{k+1/2} at a right-angle in the re-scaled (X,Y) plan. Such lines are known as equipotential curves and can be determined by solving the following equation

V_{Y}δY=−V_{X}δX (55)

We now consider the connex domain Ω_{k,i} formed by the intersection of St_{k-1/2} and St_{k+1/2} and E_{k,i+1/2} and E_{k,i-1/2}. (In a connex set any two points in the set may be connected by a line that is made up of points that are all entirely within the set.) The boundary Γ_{k,i} of this volume is the union of four segments, as illustrated in FIGS. 17a and 17b:

Γ_{k,i}=h_{k,i-1/2}∪h_{k,i+1/2}∪g_{k-1/2,i}∪g_{k+1/2,i} (56)

g_{k-1/2,i} and g_{k+1/2,l} are formed by the segments along St_{k-1/2} and St_{k+1/2} respectively, between E_{k,i+1/2} and E_{k,i-1/2}. By the definition of streamlines, no fluid flows across g_{k-1/2,i} and g_{k+1/2,i} and therefore, the volumetric rate Q_{k,i-1/2} per unit thickness along z, across h_{k,i-1/2} equals that across h_{k,i+1/2}:

Q_{k,i+1/2}=Q_{k,i-1/2}=Qₖ (57)

If the flow occurs in a region where the fluids are compressible then, the mass rate Q^{m} per unit thickness along z, across h_{k,i-1/2} is linked to that across h_{k,i+1/2} as follows:

δt(Q_{k,i-1/2}^{m}(t)−Q_{k,i+1/2}^{m}(t))=(m_{k,i}(t+δt)−m_{k,i}(t)) (58)

m_{k,i} is the mass of fluid per unit thickness along z contained in Ω_{k,i}.

We now consider 2 cases:

1. The fluid flowing within Ω_{k,i} is incompressible

2. The fluid flowing within Ω_{k,i} is compressible

### Case 1: In this case, we have

Q_{k,i+1/2}=Q_{k,i-1/2}=Qₖ (57)

By integration of Darcy's law:

$${Q}_{k , i + 1 / 2} = - ( {p}_{k , i + 1} - {p}_{k , i} ) {T}_{k , i + 1 / 2} \\ {T}_{k , i + 1 / 2} = \frac{1}{{\int }_{{\overline{s}}_{k , i}}^{{\overline{s}}_{k , i + 1}} \frac{1}{\overline{h} ( \overline{s} ) {k}^{′} ( \overline{s} ) M ( \overline{s} )} d \overline{s}} \qquad ( 59 )$$

k′ is defined in (46). h̅( s̅) is the curvilinear length of the segment along the equipotential intersecting Stₖ at a distance s̅ from s_{k,0} and contained within Ω_{k,i}. In the limit of a large number of streamlines, one can estimate h̅( s̅) as follows:

$$\overline{h} ( \overline{s} ) = \frac{‖ \vec{V} ‖ ( 0 )}{‖ \vec{V} ‖ ( \overline{s} )} \overline{h} ( 0 ) \qquad ( 60 )$$

$$\frac{‖ \vec{V} ‖ ( 0 )}{‖ \vec{V} ‖ ( \overline{s} )}$$

can be easily determined from (41) and (42), and h̅(0) is given by the set Sₖ of the streamline origins:

$${S}_{k} = \{ {s}_{k , 0} , {s}_{k , 1} , … , {s}_{k , m} \} \\ {s}_{k , i} = ( {x}_{k , i} , {y}_{k , i} ) \\ ( {x}_{k , 0} , {y}_{k , 0} ) = ( {x}_{sk}^{0} , {y}_{sk}^{0} ) \qquad ( 49 )$$

h̅(0) can be approximated as follows:

$${\overline{h}}_{k} ( 0 ) \approx \frac{1}{2} [ \sqrt{{( {x}_{k + 1 , 0} - {x}_{k , 0} )}^{2} + {( {y}_{k + 1 , 0} - {y}_{k , 0} )}^{2}} + \sqrt{{( {x}_{k - 1 , 0} - {x}_{k , 0} )}^{2} + {( {y}_{k - 1 , 0} - {y}_{k , 0} )}^{2}} ] \qquad ( 61 )$$

### T_{k,i+1/2} may be approximated as follows

$${T}_{k , i + 1 / 2}^{- 1} \approx \frac{1}{{k}^{′} ( {\overline{s}}_{k , i + 1 / 2} ) h ( {\overline{s}}_{k , i + 1 / 2} ) {M}_{k , i + 1 / 2}} ( {\overline{s}}_{k , i + 1} - {\overline{s}}_{k , i} ) \\ {M}_{k , i + 1 / 2} = \{ \begin{matrix}M ( {\overline{s}}_{k , i} ) if ( {p}_{k , i + 1} - {p}_{k , i} ) < 0 \\ M ( {\overline{s}}_{k , i + 1} ) if ( {p}_{k , i + 1} - {p}_{k , i} ) > 0\end{matrix} \qquad ( 62 )$$

### Case 2: In this case, we have

$$\begin{matrix}δ t ( {Q}_{k , i - 1 / 2}^{m} ( t ) - {Q}_{k , i + 1 / 2}^{m} ( t ) ) = ( {m}_{k , i} ( t + δ t ) - {m}_{k , i} ( t ) ) & ( 63 ) \\ {Q}_{k , i + 1 / 2}^{m} = - ( {p}_{k , i + 1} - {p}_{k , i} ) {T}_{k , i + 1 / 2}^{m} \\ {T}_{k , i + 1 / 2}^{m} = \frac{1}{{\int }_{{\overline{s}}_{k , i}}^{{\overline{s}}_{k , i + 1}} \frac{1}{ρ ( p ( \overline{s} ) ) \overline{h} ( \overline{s} ) {k}^{′} ( \overline{s} ) M ( \overline{s} )} d \overline{s}} & ( 64 )\end{matrix}$$

k′ is defined in (46). h̅( s̅) is the curvilinear length of the segment along the equipotential intersecting Stₖ at a distance s̅ from s_{k,0} and contained within Ω_{k,i}. ρ is the density of the fluid, assumed to be a function of the pressure p.

T_{k,i+1/2}^{m} may be approximated as follows:

$${( {T}_{k , i + 1 / 2}^{m} )}^{- 1} \approx \frac{1}{{k}^{′} ( {\overline{s}}_{k , i + 1 / 2} ) h ( {\overline{s}}_{k , i + 1 / 2} ) {ρ}_{k , i + 1 / 2} {M}_{k , i + 1 / 2}} ( {\overline{s}}_{k , i + 1} - {\overline{s}}_{k , i} ) \\ {M}_{k , i + 1 / 2} = \{ \begin{matrix}M ( {\overline{s}}_{k , i} ) if ( {p}_{k , i + 1} - {p}_{k , i} ) < 0 \\ M ( {\overline{s}}_{k , i + 1} ) if ( {p}_{k , i + 1} - {p}_{k , i} ) > 0\end{matrix} \\ {ρ}_{k , i + 1 / 2} = \{ \begin{matrix}ρ ( {\overline{s}}_{k , i} ) if ( {p}_{k , i + 1} - {p}_{k , i} ) < 0 \\ ρ ( {\overline{s}}_{k , i + 1} ) if ( {p}_{k , i + 1} - {p}_{k , i} ) > 0\end{matrix} \qquad ( 65 )$$

### Cases 1 & 2:

The mobility M( s̅_{k,i}) can be determined by solving mass transport along the streamline Stₖ. Mass transport may consist either of the two following approaches:
1. Mass conservation equation of the different species and fluids under consideration. These equations allow the determination of the concentrations and saturations of the different species and fluids, respectively, at any time along a given streamline. From the distribution of the concentrations and saturations, the average fluid mobility can be computed.
2. Front tracking of various mobility fronts. As fluids flow along the streamlines, a range of mobility values propagates along the streamlines. Between two fronts, each associated with a different value of the fluid mobility, the fluid mobility is approximated as being constant.

We illustrate method 2 in the following.

It is common knowledge in the industry that, as acid flows within a carbonate rock, wormholes propagate. It has been found by some authors that the velocity at which wormholes propagate is a function of the flow velocity around the wormhole. Therefore, some authors have proposed the following algorithm to track the tip of the wormholes with time.

$$\frac{\partial {\vec{T}}_{w}}{\partial t} ( t ) = \frac{1}{{ϕ}_{0}} \frac{{\vec{V}}_{D} ( t , {x}_{w} , {y}_{w} )}{{θ}_{0} ( {\vec{V}}_{D} ( t , {x}_{w} , {y}_{w} ) )} \qquad ( 66 )$$

\vec{T}_{w}=(x_{w},y_{w}) is the position vector tracking the front formed by the tip of the wormholes. φ₀ is the initial porosity of the rock. θ₀(\vec{V}_{D}(t,x_{w},y_{w})) is known as the pore-volume to breakthrough and a function of the velocity. The disclosure above describes how θ₀ can be measured from linear core-flood experiments. The inverse of θ₀ is, by definition, the relative velocity at which the tip of the wormholes propagate, i.e. relative to the mean Darcy velocity Q/A.

Two forms of (66) have been proposed in the literature. For linear flow fields, as observed during core-flooding experiments for instance, (66) can be re-written as follows:

$$\frac{\partial {x}_{w}}{\partial t} ( t , x , y ) = \frac{1}{{ϕ}_{0}} \frac{u ( t )}{{θ}_{0} ( u )} = \frac{1}{{ϕ}_{0}} \frac{Q ( t )}{A {θ}_{0} ( \frac{Q}{A} )} \qquad ( 67 )$$

where x_{w} is the distance traveled by the tip of the wormholes in the flow direction (assumed to be the x-axis direction in this case), u is the x-component of the Darcy velocity \vec{V}_{D}, Q the flow-rate and A the cross-section area in the plane orthogonal to the x-axis. For radial flow, some authors have proposed the following:

$$\frac{\partial {r}_{w}}{\partial t} ( t , x , y ) = \frac{1}{{ϕ}_{0}} \frac{{u}_{r} ( t , {r}_{w} )}{{θ}_{0} ( {u}_{r} ( t , {r}_{w} ) )} = \frac{1}{{ϕ}_{0}} \frac{Q ( t )}{2 πδ {zr}_{w} {θ}_{0} ( {u}_{r} ( t , {r}_{w} ) )} \qquad ( 68 )$$

where r_{w} is the radial distance traveled by the front formed by the tip of the wormholes and δz is the thickness of the flow domain in the direction orthogonal to the radial plane.

Besides, it is commonly admitted that the mobility of the fluid, upstream of the front tracking the wormhole tips, is constant. In this region, the fluid mobility is high due to an increase of the permeability generated by the wormholes. If we note μ the viscosity of the acid, bₖ is permeability increase in the wormhole region, then, the fluid mobility upstream of the wormhole tip front is:

$$M = {M}_{w} = \frac{{k}_{0}}{{μ}_{d} \frac{Δ {p}_{bt}}{Δ {p}_{0}}} \qquad ( 69 )$$

This value of the fluid mobility can be applied in the interval [ s̅_{k,0}, s̅_{k,w}] along the streamline Stₖ, where s̅_{k,w} is the curvilinear distance traveled by the front formed by the tips of the wormholes along Stk. We propose an extension of (67) and (49) to arbitrary flow fields along a streamline:

$$\frac{\partial {\overline{s}}_{k , w}}{\partial t} ( t ) = \frac{1}{{ϕ}_{0}} \frac{{Q}_{k , w} ( t )}{\overline{h} ( {\overline{s}}_{k , w} ( t ) ) {θ}_{0} ( {u}_{k , w} ( t ) )} \\ {u}_{k , w} ( t ) = \frac{{Q}_{k , w} ( t )}{\overline{h} ( {\overline{s}}_{k , w} ( t ) )} \qquad ( 70 )$$

where Q_{k,w}(t) is the volumetric flow rate per unit thickness along the z-axis on streamline Stₖ, at a distance s̅_{k,w} from its origin. Q_{k,w} may be determined by either solving (57) if the flow is that of an incompressible fluid, or (63) otherwise. h̅( s̅_{k,w}) may be determined used Equation (60).

Similarly, as various mobility fronts develop along the streamlines, other variable may be introduced to track the curvilinear distance traveled by such fronts. As described above, another zone of constant mobility has been introduced for Self-Diverting acids, propagating ahead to the wormhole tips. Equation (13) is used for predicting the mobility Mᵣ in this zone; this equation is reproduced in part in Equation (72). Also, as shown above, the relative velocity at which this front propagates is shown to be the inverse of θᵣ, a quantity which can be assessed from linear core-flood experiments (see equation (2).

To solve the general flow problem of a self-diverting acid in non-axisymmetric flow about the borehole, we therefore define a new variable s̅_{k,r} measuring the distance traveled on Stₖ by the zone in which the fluid mobility is equal to Mᵣ and, such that,

$$\begin{matrix}\frac{\partial {\overline{s}}_{k , r}}{\partial t} ( t ) = \frac{1}{{ϕ}_{0}} \frac{{Q}_{k , r} ( t )}{\overline{h} ( {\overline{s}}_{k , r} ( t ) ) {θ}_{r} ( {u}_{k , r} ( t ) )} & ( 71 ) \\ {u}_{k , r} ( t ) = \frac{{Q}_{k , r} ( t )}{\overline{h} ( {\overline{s}}_{k , r} ( t ) )} \\ M = {M}_{r} = \frac{{k}_{0}}{\frac{{μ}_{d}}{ } \frac{Δ {p}_{r}}{Δ {p}_{0}} \frac{{θ}_{0}}{{θ}_{0} - {θ}_{r}}} & ( 72 )\end{matrix}$$

Q_{k,r}(t) is the volumetric flow rate per unit thickness along the z-axis on streamline Stₖ, at a distance s̅_{k,r} from its origin. Q_{k,r} may be determined by either solving (57) if the flow is that of an incompressible fluid, or (63) otherwise.

In various embodiments, the method detailed above is carried out in as many mobility zones as are of interest to the user.

### Steps e), f), and g)—Update Parameters and Iterate

Once the various fronts under interest have been propagated over a time step δt, the flow domain can be updated. Because the wormholes change the permeability in the zone through which they have propagated, the flow field at the next time-step may be different. Therefore, the streamlines will have moved and a new set of streamlines must be determined. In the following, we present a method for doing so:

Since the permeability generated by the wormholes is several orders of magnitude larger than the original permeability of the rock, one can consider that the pressure drops between the wellbore and the tip of the wormholes are negligible. Consequently, the contour of the zone defined the region around the wellbore through which the wormholes have propagated can be used as in Step b) to distribute the source points which will serve as streamline origins. For convenience, these source points can be taken as the point defined by the s̅_{k,tip}. Then Step b) can be reiterated to generate the new streamlines for the next time step. This algorithm is illustrated in FIG. 18. (FIG. 18 illustrates updating of the streamlines after each time step. [181]: extent of the wormholed zone after first time step. [182]: extent of the wormholed zone after second time step.) Points [183] are the initial source points used as streamlines origins along the wellbore contour [186]. Points [184] represent the position of the wormhole tips after the first time step; these serve as source points to re-calculate the streamlines after the first time step. Points [185] represent the position of the wormhole tips after the second time step; they serve as source points to re-calculate the streamlines after the second time step, and so on. Dotted lines [188] illustrate the initial streamlines; solid lines [187] illustrate new streamlines after the first time step.

Because the ultimate goal of matrix acidizing is to alter fluid flow in a reservoir, reservoir engineering must provide the goals for a design. In addition, reservoir variables may impact the treatment performance.

In various embodiments, the overall procedure is implemented into an acid placement simulator to predict the fate of a given design in the field. The simulator includes input means for input of reservoir parameters, formation parameters, acid formulations, results of core flood experiments, and the like; a processor unit connected to the input means and programmed with software instructions that carry out the steps outlined above, including the use of the complex potential to determine streamlines used to solve for the flow in the geologic formation, and output means communicating with the for reporting the results of the simulations. The results include treatment levels and rates for a given acid formulation in a given geological formation to enhance production of oil or gas from the formation.

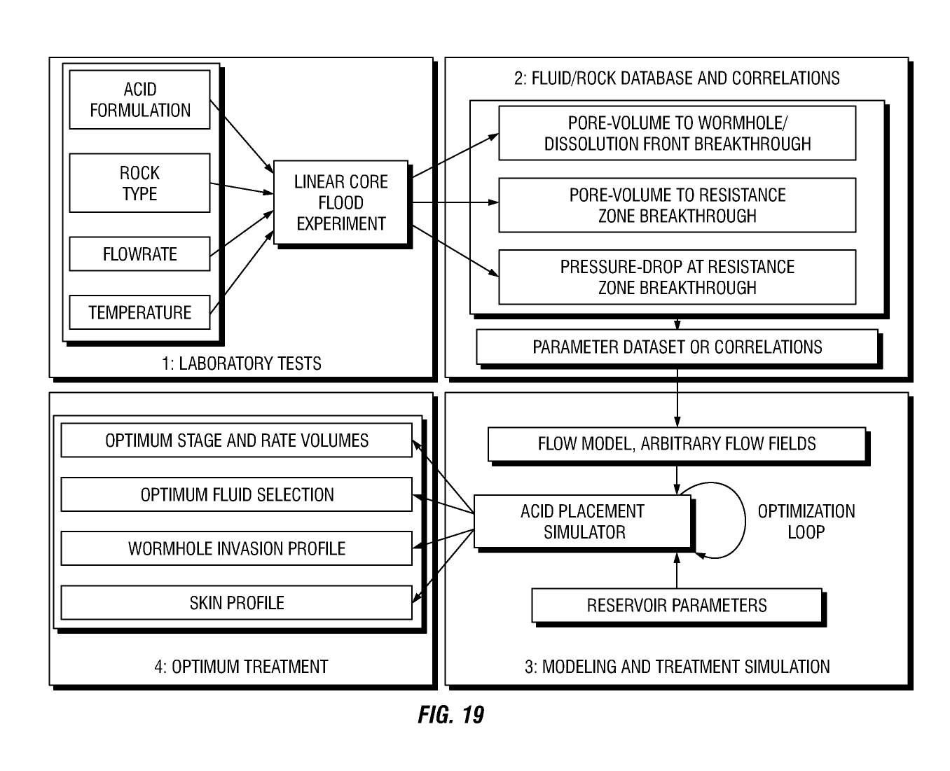

A global methodology used by field engineers is described in FIG. 19. The optimization in FIG. 19 makes use of the above methodology to predict a given acid treatment performance. It is possible to improve a design by
Changing operational parameters such as:
   Pumping rate
   Acid volume
   Acid formulation
   Number of acid stages
Understanding important parameters controlling the treatment outcome such as:
   Operational parameters
   Reservoir parameters
   Wellbore parameters
   Conveyance parameters

In various embodiments, the concepts detailed in this document are integrated into a software that solves the flow of acid around the wellbore, into the reservoir. Below is a non-limiting example of how this software is used.

### EXAMPLE

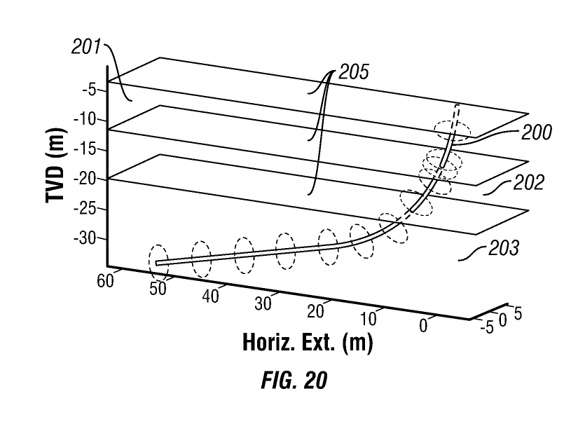

The example illustrated in FIG. 20 shows a well [200] crossing 2 producing zones of a reservoir bounded by flow barriers [205] separating the zones of flow. The top zone [201] of the reservoir has a horizontal permeability kₕ equal to 20 mD and is about 10 meters thick. The vertical permeability kᵥ is 5 times smaller, equal to 4 mD. In this part of the reservoir, the wellbore trajectory forms an angle α varying between 0 and 20 degrees. Underneath the top zone, a non-permeable and non-producing zone [202] with a thickness of about 10 meters, is crossed by the well [200]. No flow will take place in this zone. Finally, at the bottom [203], the wellbore trajectory bends until an angle α around 78 degrees is reached. In this part of the reservoir, the horizontal permeability kₕ is 2 mD and the vertical permeability is 3 mD. The thickness of the bottom zone is about 22 meters.

The nature of the rock in the top and bottom zones [201] and

of the reservoir is known, and core flood experiments have been performed on cores extracted from these zones to assess the required flow parameters Θ₀, Θᵣ and Δpᵣ to model the flow of the acids of interest.

In the top zone [201], Equation (24) dictates that the flow would be mostly horizontal (in the bedding plane) and therefore a radial flow model will be applied to simulate the flow of acid, similar to Equation (68). In the bottom zone [203], the wellbore is close to horizontal and Equation (24) determines that the flow will be mostly vertical. In this zone a flow model similar to (70) is therefore applied.

The wellbore is then divided into multiple segments, and the reservoir in multiple layers in a way similar to FIG. 9. The number of segments, and therefore layers, is selected by the engineer and is large enough for him to believe that the reservoir is discretized accurately enough.

In the layers within the bottom zone of the reservoir, streamlines are computed according to the procedure described above. The interface at the top of the bottom zone due to the presence of the impermeable middle zone forms a flow barrier. Similarly, the bottom of the bottom zone is another flow barrier. Near the top of the bottom zone, the streamlines

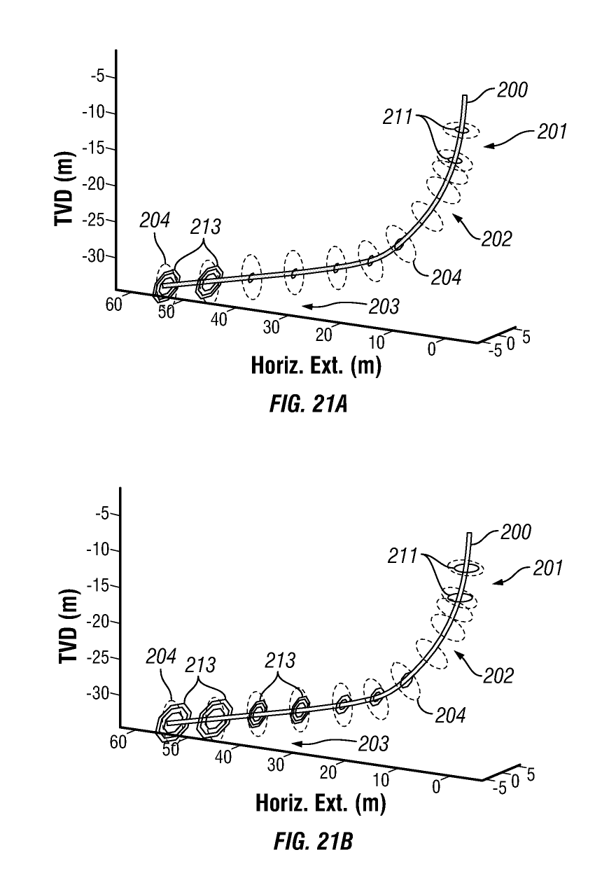

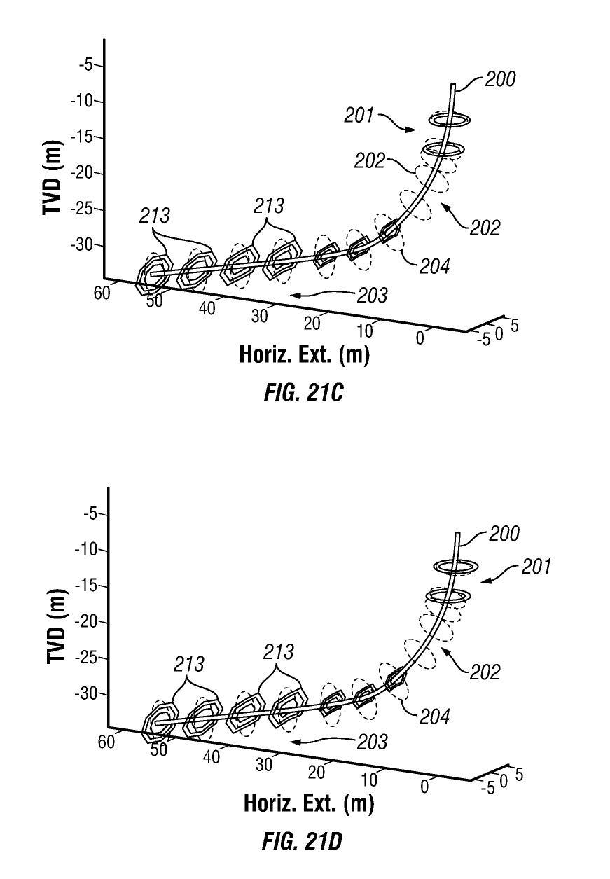

Then, the engineer starts the simulation consisting of pumping a certain volume of acid, 15% HCl in this case, for which he knows the values of the parameter Θ₀ in the two zones [201] and [203] as mentioned above. The goal is to ensure that the wormholes formed by the acid will extent at least 5 meters away from the wellbore in order to obtain an optimum stimulation of the well. The depth of 5 meters is represented by the dashed lines around the wellbore [200] in FIG. 21, for scale reference. The original design consisted of pumping a volume of acid corresponding to 100 gallons per foot (approximately 1250 liters per meter) of wellbore length. The rate of injecting was fixed. FIG. 21 shows the evolution of the wormhole fronts in the top and bottom zone for four treatments: FIG. 21a—25 gal/ft; FIG. 21b—50 gal/ft; FIG. 21c—75 gal/ft; FIG. 21d—100 gal/ft. The top and bottom zones show various lines, each corresponding to the front formed by the tip of the wormholes at a given time. As time runs, the lines are deeper and deeper into the reservoir, showing that the wormholes extend into the reservoir. In the top zone [201], the front [211] formed by the tip of the wormholes is circular, due to radial flow. In the bottom zone [203], the contours formed by the fronts [213] of the wormhole tips are not circular due to the non radial flow obtained when flowing along the streamlines. In FIG. 21, these are shown as though there were 8 wormhole tips at each location at which the fronts are shown; series of octagons show the progression of the contours. Dotted lines [204] show where the front would be if flow were radial.

From FIG. 21, one can see that in order to reach the target depth of 5 m, in this case, 75 gal/ft (approximately 936 liters per meter) of acid is sufficient. It is therefore possible to reduce the cost of acid required to achieve the target. This is a result of the optimization loop illustrated in FIG. 19.

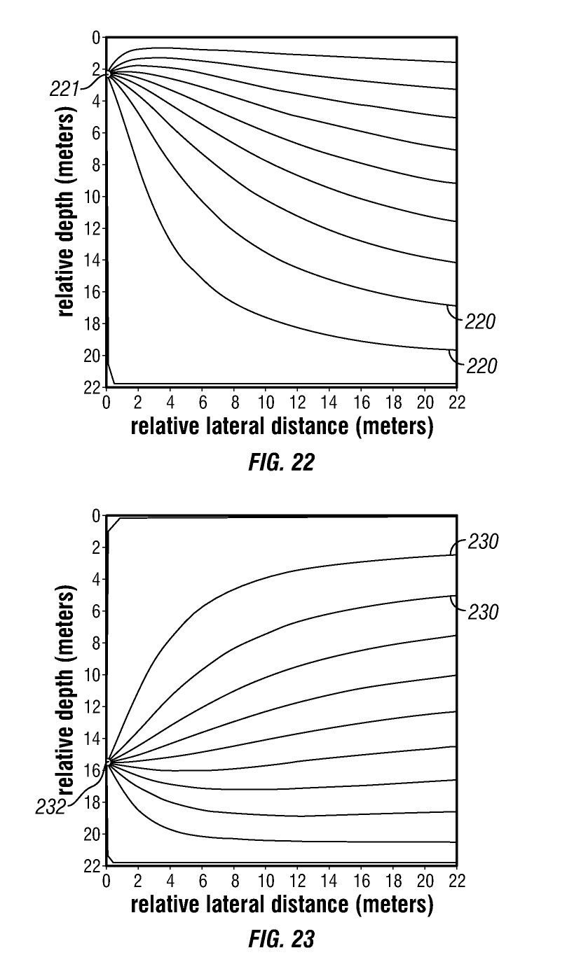

FIG. 22 shows streamlines [220] originating from the well bore [221] in a layer close to the top of the bottom zone [203].

FIG. 23 show streamlines [230] originating from the well bore [232] in a layer closer to the bottom of the bottom zone [203].

I claim:

1. A method for solving the flow of acid from a wellbore segment to a corresponding reservoir layer during a matrix acidizing simulation, comprising:
a) Defining the initial geometry of the domain in which the flow problem is to be solved;
b) Determining the complex potential associated with the flow problem in the domain under consideration;
c) Determining streamlines from the complex potential in the domain under consideration;
d) Using the streamlines to solve flow over a time step δt to propagate acid within the domain and update wormhole extent;
e) Updating the definition of the domain according to wormhole extent;
f) Updating the time;
g) Iterating as desired from step b).

2. A method according to claim 1, comprising determining the streamlines by a finite volume method.

3. A method according to claim 3, wherein the method includes simulation of the flow of a self-diverting acid.

4. A method of optimizing acid treatment of a hydrocarbon containing carbonate reservoir, comprising:
carrying out linear core flood experiments varying one or more parameters selected form the group consisting of acid formulation, rock type, flow rate, and temperature;
deriving the following functions from the experiments, as a function of the parameters:
Θₒ—the pore volume to wormhole/dissolution front breakthrough; and, if the acid formulation is a self-diverting acid:
Θᵣ—the pore volume to resistance zone breakthrough; and
Δpᵣ—the pressure drop at resistance zone breakthrough;
solving the flow of acid from a wellbore segment to a corresponding reservoir layer during a matrix acidizing simulation by a process comprising:
a) defining the initial geometry of the domain in which the flow problem is to be solved;
b) determining the complex potential associated with the flow problem in the domain under consideration;
c) determining streamlines from the complex potential in the domain under consideration;
d) using the streamlines to solve flow over a time step δt to propagate acid within the domain and update wormhole extent;
using the simulator in an optimization loop together with known and/or estimated reservoir parameters; and
calculating at least one of the following from the simulator optimization loop:
stage and rate volumes of the acid treatment;
fluid selection for the acid treatment;
wormhole invasion profile; and
skin profile.

5. A method according to claim 4, wherein the acid is a self diverting acid.

6. A method according to claim 4, comprising optimizing at least one of
the pumping rate;
acid volume;
acid formulations; and
number of acid stages.

7. A method according to claim 5, comprising optimizing at least one of
the pumping rate;
acid volume;
acid formulations; and
number of acid stages.
